(19) United States
(12) Patent Application Publication
(10) Pub. No.: US 2006/0134697 A1
(43) Pub. Date: Jun. 22, 2006

(54) Method of preparing coded compound libraries

(75) Inventors: Kit S. Lam, Davis, CA (US); Xiaobing Wang, Davis, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Regents of the University of California, Oakland, CA (US)

(21) Appl. No.: 11/261,842

(22) Filed: Oct. 28, 2005

Related U.S. Application Data
(60) Provisional application No. 60/623,208, filed on Oct. 28, 2004.

(51) Int. Cl. C40B 40/02

(52) U.S. Cl. 435/7.1

(57) ABSTRACT

The present invention relates to methods of preparing a library of compounds, wherein each of the compounds resides on the exterior portion and is encoded by coding tags confined in each of successive zones on the interior portion of a solid support. Following screening of the compounds, the coding tags can be cleaved, and then characterized by mass spectrometry.

### CROSS-REFERENCES TO RELATED APPLICATIONS

This application is entitled to the benefit of Provisional Patent Application Ser. No. 60/623,208 filed Oct. 28, 2004, which is incorporated by reference in its entirety.

### STATEMENT AS TO RIGHTS TO INVENTIONS MADE UNDER FEDERALLY SPONSORED RESEARCH OR DEVELOPMENT

A portion of the present invention was made under federally sponsored research and development under National Institutes of Health Grant No. R33 CA 89706. The Government may have rights in certain aspects of this invention.

### BACKGROUND OF THE INVENTION

There is substantial interest in devising facile methods for the synthesis of large number of diverse compounds which can then be screened for various possible physiological or other activities. Typically, such a synthesis involves successive stages, each of which involves a chemical modification of the then existing molecules. A significant recent development has been the development of combinatorial chemistry to create chemical libraries of potential new drugs.

Combinatorial chemistry is a synthetic strategy in which chemical members of the library are made in a systematic methodology by the assembly of chemical subunits. Each molecule in the library is thus made up of one or more of these subunits. The chemical subunits may include naturally-occurring or modified amino acids, naturally-occurring or modified nucleotides, naturally-occurring or modified saccharides or other molecules, whether organic or inorganic. Typically, each subunit has at least two reactive groups, permitting the stepwise construction of larger molecules by reacting first one then another reactive group of each subunit to build successively more complex and potentially diverse molecules.

The one-bead one-compound (OBOC) combinatorial library approach has been used extensively to facilitate ligand discovery (Lam, K. S. et al., Nature, 1991, 354, 82-84). In the OBOC combinatorial method, thousands to millions of compound-beads are rapidly generated using the split-mix or split-pool synthesis approach, in such a manner that each bead displays only a single compound entity (Furka, A. et al., Int. J. Peptide Protein Res., 1991, 37, 487-493; Houghten, R. A. et al., Nature, 1991, 354, 84-86; Lam, K. S. et al., Chem. Rev. 1997, 97, 411-448). After biological screening, the positive beads are physically isolated for structural analysis using an automatic protein microsequencer in conjunction with Edman degradation chemistry.

Various indirect encoding methods have been developed to sequence small molecule-beads more readily, and the subject has been reviewed several times (Lam, K. S. et al. Chem. Rev. 1997, 97, 411-448; Czarnik, A. W. Curr. Opin. Chem. Biol. 1997, 1, 60-66; Xiao, X. Y. Front. Biotechnol. Pharm. 2000, 1, 114-149; Barnes, C., et al. Curr. Opin. Chem. Biol. 2000, 4, 346-350; Affleck, R. L. Curr. Opin. Chem. Biol. 2001, 5, 257-263). In most cases, a coding tag (comprising a coding building block and a coding linker) is synthesized on each bead in addition to the library component. These tags define the chemical history of any particular bead and hence the structure of the compound it supports. The coding tag is released from the bead following biological screening and analyzed by a highly sensitive analytical technique.

Mass spectrometry (MS) has been widely used in the analysis of combinatorial libraries due to its intrinsic sensitivity, speed of analysis, specificity of detection and automation capability. Two approaches based on mass spectrometry as sequencing technique have been developed for OBOC combinatorial libraries. They are ladder-sequencing approach and ladder-synthesis approach (FIG. 1). A typical ladder-sequencing approach used a mixture of phenylisothiocyanate (PITC) and phenylisocyanate (PIC) in each step of sequential Edman degradation to generate a peptide ladder on each bead (Chait, B. T. et al., Science, 1993, 262, 89-92; Wang, P. et al., J. Comb. Chem., 2001, 3, 251-254; Sweeney, M. C. et al., J. Comb. Chem., 2003, 5, 218-222). The ladder members from a positive bead were released and subsequently analyzed by mass spectrometry to elucidate the sequences of the original peptides by calculating the mass differences between adjacent peaks. The approach is limited to Edman degradative libraries such as α-peptide or peptoid libraries (consist of α-amino acids) with free N-terminus (Davies, M. et al., Teteahedron Lett, 1997, 38, 8565-68). It cannot be applied to other diverse libraries such as N-terminal blocked libraries, β-peptide libraries (consist of β-amino acids), inverted peptide libraries (from C-terminus to N-terminus) and peptidomimetic or small molecule libraries. In ladder-synthesis approach, the bead-bound peptides were encoded with a series of sequence-specific, partially terminated products by capping a small portion of the peptides at each coupling cycle of the library synthesis. Thus a ladder for each compound had been generated prior to biological screening (Spetov, N. et al., U.S. Pat. No. 5,470,753; Youngquist, R. S. et al., J. Am. Chem. Soc., 1995, 120, 13312-13320). Other variations of this “ladder-synthesis” method include the use of the same amino acid but different protecting group as capping reagent (e.g., use Boc-Ala as the capping reagent when coupling Fmoc-Ala) (Hilaire, P. M. S. et al., J. Am. Chem. Soc. 1998, 120, 13312-13320) or the use of partial incorporation of methionine at each coupling step (e.g., use 5% of methionine and 95% of amino acid as coupling reagents in each step such that a ladder can be obtained upon cyanogen bromide cleavage). However, the major disadvantage of the conventional ladder-synthesis method is that all the ladder members are displayed together with the full-length library compound on the bead surface. These ladder members may interact with the screening probes, thus complicating the interpretation of the screening result. To overcome the disadvantage and to expand application to other libraries, such as N-terminal blocked libraries, β-peptide libraries (consist of β-amino acids), inverted peptide libraries (from C-terminus to N-terminus), non-peptide oligomers and peptidomimetic or small molecule libraries, there is a need to develop a new ladder-synthesis method for OBOC libraries, which have libraries of compounds residing on the surface or outer layer or exterior portion of the beads and coding tags confined in the interior portion of the beads.

Some remarkable features and advantages in the new ladder-synthesis method include (1) utilizing one building block, instead of a mixture of two building blocks, in each coupling step to achieve uniformed and constant coupling rate; (2) topologically confining the truncated ladder members to bead interior and the complete library compounds to bead surface eliminating the potential interference of truncated members with biological screening and assays; and (3) having reverse ladder arrangement resulting in interference free Edman microsequencing. The method is also robust, versatile and easy to control.

For the forgoing reasons, what is needed in the art is a highly efficient encoding strategy that is well-suited to libraries of peptides, non-peptide oligomers, peptidomimetics and small organic molecules. Surprisingly, the present invention meets this and other needs.

### BRIEF SUMMARY OF THE INVENTION

The present invention relates to a novel method for coding peptide and non-peptide libraries. The novel feature of this method is the preparation of a library of target compounds residing on the surface or outer layer or in a zone on the exterior portion of a solid support and coding tags or truncated members confined in each subsequent zones on the interior portion of the solid support. In addition, libraries of target compounds and coding tags can also be each individually attached to the solid support via a cleavable linker. Following preparation of the compound libraries, the coding building blocks are cleaved from the solid support and characterized to decode the compound.

In one aspect, the present invention provides a method for preparing a library of compounds, comprising: a) providing a plurality of beads wherein each of said beads has an interior and an exterior portion and wherein each of said beads is divided into a plurality of zones extending from said exterior into said interior and wherein each of said zones consists of a plurality of reactive functional groups; b) contacting a first bead with a protective component such that said reactive functional groups of said first bead react with said protective component to afford a protected functional group; c) contacting said first bead with a deprotecting component such that said protected functional groups in a first zone on said exterior of said first bead revert to said reactive functional groups; d) contacting said first bead with a first reactive component such that said reactive functional groups in said first zone react with said first reactive component to afford a first building block of a compound precursor; e) contacting said first bead with a deprotecting component such that said protected functional groups in a subsequent zone on said interior of said first bead revert to said reactive functional groups; f) contacting said first bead with a subsequent reactive component such that said compound precursor reacts with said subsequent reactive component to afford a subsequent building block of said compound precursor, said reactive functional groups in said subsequent zone react with said subsequent reactive component to afford a coding tag, and any coding tag in any previous zone reacts with said subsequent reactive component to afford a coding tag additionally coding for said subsequent building block; g) repeating steps e)-f) until said first compound has been prepared; and subjecting additional beads to steps b)-g) with additional reactive components to prepare said library of compounds.

In a further aspect, the present invention provides a method for preparing a library of compounds, further comprising the step of cleaving each of said compounds from each of said beads.

In another further aspect, the present invention provides a method for preparing a library of compounds, wherein said reactive component reacts with said reactive functional groups via a reaction selected from the group consisting of amine acylation, reductive alkylation, aromatic reduction, aromatic acylation, aromatic cyclization, aryl-aryl coupling, [3+2] cycloaddition, Mitsunobu reaction, nucleophilic aromatic substitution, sulfonylation, aromatic halide displacement, Michael addition, Wittig reaction, Knoevenagel condensation, reductive amination, Heck reaction, Stille reaction, Suzuki reaction, Aldol condensation, Claisen condensation, amino acid coupling, amide bond formation, acetal formation, Diels-Alder reaction, [2+2] cycloaddition, enamine formation, esterification, Friedel Crafts reaction, glycosylation, Grignard reaction, Homer-Emmons reaction, hydrolysis, imine formation, metathesis reaction, nucleophilic substitution, oxidation, Pictet-Spengler reaction, Sonogashira reaction, thiazolidine formation, thiourea formation and urea formation.

In one more aspect, the present invention provides a method for preparing a library of compounds, comprising: a) providing a plurality of beads wherein each of said beads has an interior and an exterior portion and wherein each of said beads is divided into a plurality of zones extending from said exterior into said interior and wherein each of said zones consists of a plurality of reactive functional groups and a plurality of linkers, and wherein each said reactive functional groups is independently connected to each said beads through each said linkers; b) contacting a first bead with a protective component such that said reactive functional groups of said first bead react with said protective component to afford a protected functional group; c) contacting said first bead with a deprotecting component such that said protected functional groups in a first zone on said exterior of said first bead revert to said reactive functional groups; d) contacting said first bead with a first reactive component such that said reactive functional groups in said first zone react with said first reactive component to afford a first building block of a compound precursor; e) contacting said first bead with a deprotecting component such that said protected functional groups in a subsequent zone on said interior of said first bead revert to said reactive functional groups; f) contacting said first bead with a subsequent reactive component such that said compound precursor reacts with said subsequent reactive component to afford a subsequent building block of said compound precursor, said reactive functional groups in said subsequent zone react with said subsequent reactive component to afford a coding tag, and any coding tag in any previous zone reacts with said subsequent reactive component to afford a coding tag additionally coding for said subsequent building block; g) repeating steps e)-f) until said first compound has been prepared; and subjecting additional beads to steps b)-g) with additional reactive components to prepare said library of compounds.

In another aspect, the present invention provides a method for preparing a library of compounds, further comprising: a) contacting the beads with a first modifying agent to afford a modified compound and modified coding tags; and b) repeating step a) with additional modifying agents to prepare said library of compounds.

In an additional aspect, the present invention is directed to a library of compounds prepared by the methods described in the present invention.

In yet another aspect, the present invention provides a method for preparing a library of compounds using a split-pool methodology.

In still another aspect, the present invention provides a method for preparing a coded library of compounds, comprising: a) providing a plurality of beads, wherein each said beads has an interior portion and an exterior portion and wherein each of said beads is divided into a plurality of zones extending from said exterior portion into said interior portion and wherein each of said zones consists of a plurality of reactive functional groups; b) contacting each of said beads with a protective component; c) contacting each of said beads with a deprotecting component; d) splitting the beads into two or more separate pools; e) contacting the first reactive components with one or more first reactive functional groups in the two or more separate pools such that a first reactive functional group reacts with one of the first reactive components to afford a first building block, and a first reactive functional group reacts with one of the first reactive components to afford a first coding building block, wherein the contacting step yields subsequent compound precursors; f) mixing the subsequent compound precursors from the two or more separate pools into a single pool; g) splitting the subsequent compound precursors into two or more separate pools; h) contacting the subsequent compound precursors in the two or more separate pools with a successive reactive component such that a subsequent reactive functional group reacts with the successive reactive component to afford a subsequent building block, and a subsequent reactive functional group reacts with the successive reactive component to afford a subsequent coding building block, wherein the contacting step yields further compound precursors; i) repeating steps f)-h), wherein the further compound precursors of step h) become the subsequent compound precursors of step f), until the library of compounds has been prepared.

In a different aspect, the present invention provides a method for identifying a compound that binds to a target, said method comprising: a) contacting a compound prepared with said target; and b) determining the functional effect of said compound upon said target.

In another different aspect, the present invention provides a method for identifying a compound in a library of compounds prepared, comprising: a) cleaving each of a series of compounds and each of a series of coding tags from each of said beads; b) subjecting said compounds and said coding tags to mass spectral analysis; and c) calculating the mass difference between the mass of a compound peak or a coding peak and a peak corresponding to a linker in order to identify said compound.

In yet another different aspect, the present invention provides a method for preparing a library of compounds, comprising: a) providing a plurality of beads wherein each of said beads has an exterior portion and an interior portion and wherein each of said beads is divided into a plurality of zones extending from said exterior into said interior; and b) attaching each of said compounds in a first zone on said exterior portion of each of said beads and a coding tag in each of a subsequent zone on the interior portion of each of said beads to afford a coded library of compounds.

### BRIEF DESCRIPTION OF THE DRAWINGS

These and other features, aspects, and advantages of the present invention will become better understood with regard to the following description, appended claims, and accompanying drawings where:

FIG. 1. Methods for determining peptide sequence on a single OBOC combinatorial library bead. A comparison of ladder-sequencing approach (A) and ladder synthesis approach (B) with the partial deprotection approach for ladder-synthesis method (C) of the present invention.

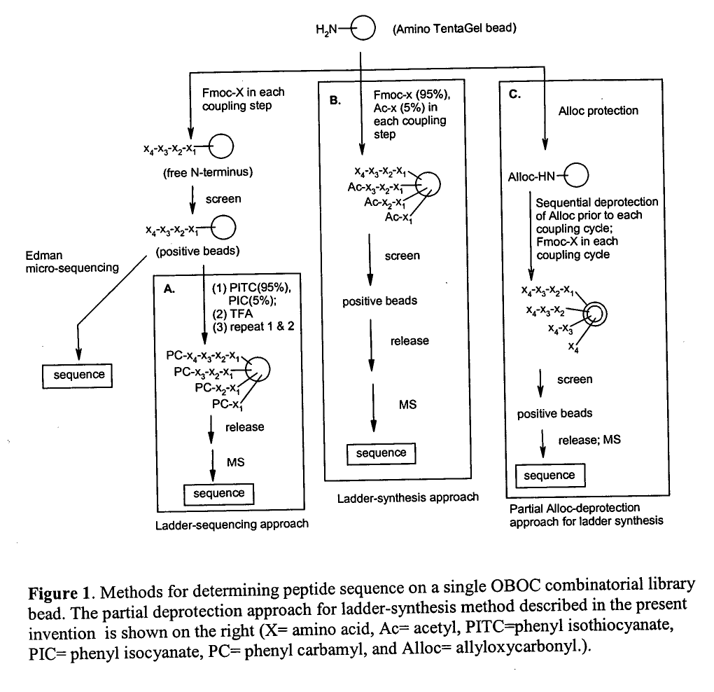

FIG. 2. Scheme showing the synthesis and encoding and decoding mechanism of the present invention. Following preparation of the compound, the bead is screened for its biological activity and those beads demonstrating activity have their coding building blocks cleaved and decoded via mass spectrometry. As used herein, “R” stands for reactive functional group; “P” stands for protected functional group; “B” stands for building blocks with or without protected function groups attached. For example, B₁, B₂ and B₃ stand for the initial three building blocks.

FIG. 3. Degree of deprotection as a function of exposure time to the deprotecting component, palladium phosphine complex, in two different organic solvents: DCM/Ether (50:50, v/v) (▴), and DCM (▪).

FIG. 4. Schematic of two sequencing techniques (protein microsequencer and MALDI-TOF MS) carried out on two different sections of the same compound-bead prepared by the new ladder-synthesis method. The smaller piece is sequenced directly, without releasing of the ladders, with the automatic protein microsequencer using Edman chemistry. The larger piece is treated with CNBr and the releasate analyzed by MALDI-TOF MS.

FIG. 5. The mass spectrum of the model peptide ladder released from one single bead prepared by the ladder-synthesis method of the present invention. The peptide sequence (starting from N-terminus) is identified by calculating the mass differences between adjacent peaks from low mass to high mass. The first residue was determined as P by deducting 557 (mass of protonated cleavage linker, not appear in the mass spectrum) from the mass of the first peak. The full-length peptide sequence was identified as P-L(/I)-G-I(/L).

FIG. 6. General structure of ladder compounds on an encoded pentapeptide library bead, and hypothetical mass spectrum of releasate with six mass peaks (M₁ to M₆) from one bead. The chemical structure of the cleavable linker is shown.

FIG. 7. Typical mass spectra of releasate obtained from single pentapeptide library bead prepared by the new ladder-synthesis method of the present invention. (a) The full-length compound sequence was determined as L-1-A-T-L according to the decoding strategy (coding tag present); (b) the compound sequence was identified as T-L-G-H-T (coding tag absent). The mass of the protonated cleavage linker (M₀) is 713 (it does not appear in the mass spectra).

### DETAILED DESCRIPTION OF THE INVENTION

I. Definition

As used herein, the term “library of compounds” refers to a collection of compounds on separate phase support particles in which each separate phase support particle contains a single structural species of the synthetic test compound. Each support contains many copies of the single structural species.

As used herein, the term “compound” refers to a small molecule consisting of 2 to 100, and more preferably, 2-20, functional groups. In one embodiment, the compound is an aromatic heterocycle with one or more functional groups. In another embodiment, the compound can be a peptide, oligomer or polymer.

As used herein, the terms “encode”, “encoded” and “encoding” refer to a library of compounds in which each distinct species of compound is paired on each separate solid phase support with at least one coding building block containing a functional group that is the same or mimics a particular functional group of the compound. In one embodiment, there is one coding building block for each functional group on the compound.

As used herein, the term “coding” is used as a prefix denoting that a particular feature or item is a part of the mechanism that encodes each functional group of the compounds in the library.

As used herein, the term “coding building block” refers to a chemical moiety that has been transformed by reacting a reactive functional group with a reactive component. The coding building block encodes the chemical functionality of the corresponding building block.

As used herein, the term “coding tag” refers to an intermediate compound that comprises building block(s) and optionally a linker, and is used to encode the target compound.

As used herein, the term “target compound” refers to a compound that comprises a series of building block(s) and is used for the building of a library of compounds.

As used herein, the term “linker” refers to a chemical moiety that connects the coding functional group to the solid phase support. The linker also connects the coding building block to the solid phase support. The linkers of the present invention are cleavable, and comprise components that enhance the sensitivity of the analytical tools used for decoding. Linkers of the present invention, include, but are not limited to, aminobutyric acid, aminocaproic acid, 7-aminoheptanoic acid, 8-aminocaprylic acid, lysine, iminodiacetic acid, polyoxyethylene, glutamic acid, etc. In a further embodiment, linkers of the present invention can additionally comprise one or more β-alanines or other amino acids as spacers.

As used herein, the term “interior portion” refers to that portion of the solid phase support that substantially excludes the surface of the solid phase support.

As used herein, the term “exterior portion” refers to that portion of the solid phase support that substantially includes the surface of the solid phase support.

As used herein, the term “contacting” refers to the process of bringing into contact at least two distinct species such that they can react. In one embodiment, contacting an amine and an ester under appropriate conditions known to one of skill in the art would result in the formation of an amide.

As used herein, the term “mixing” refers to the act of combining individual elements such that they cannot be easily distinguished or separated.

As used herein, the term “protective component” refers to a chemical or agent that is used to modify a reactive functional group into a protected functional group.

As used herein, the term “deprotecting component” refers to a chemical or agent that is used to modify a protected functional group into a reactive functional group.

As used herein, the term “reactive component” refers to a chemical or reagent that is used to modify a functional group into a building block.

As used herein, the term “zone” refers to that portion or part of the bead, which is a section, segment or part comprising indistinguishable layer(s) on the exterior portion or the interior portion of the beads.

As used herein, the term “compound precursor” refers to a solid support with building blocks for the compound and coding tags individually attached to the support. In one embodiment, the compound precursor is the starting point for preparing the library of compounds.

II. General

As combinatorial chemistry has become an indispensable part of compound synthesis and drug discovery, the rapid and facile encoding and screening of the compounds generated is essential. While a variety of encoding methods have been developed in order to increase the speed and ease of encoding, they all have limitations when applied to large libraries of small molecules. The present invention provides a library of compounds attached to a separate phase support, preferably functionalized resin beads. The compounds are prepared on the exterior portion of the beads while the coding tags or coding building blocks are simultaneously prepared in the interior portion of the beads. Following screening, the coding tags are cleaved from the positive beads and characterized by MS. The structures of active compounds can be readily identified according to the exact molecular masses of coding building blocks.

The present invention only uses one single building block for coupling during each coupling step, therefore avoiding the problems caused by the differential coupling rates of two different building blocks. Moreover, all the coding tags/truncated ladder members are confined to the bead interior, and only the full-length library compounds are displayed on the bead surface. As a result, the undesirable interference of ladder tags with the biological screening can be avoided. In addition, this method generates a reverse ladder that allows one to determine the peptide sequences by calculating mass differences between each two adjacent peaks in mass spectrometry.

A person of ordinary skill in the art would recognize that ordinary beads obtained from a commercial supplier, for example, those used in the present invention do not come with zones in the exterior portion or the interior portion of the beads. As used herein, zones are sections on the beads or portions within the beads having reactive functional groups, which are generated through a single or multiple steps of selective removal of the protected functional groups. A zone may be a part or the entire surface of the beads; or a part or the entire exterior portion of the beads; or a part within the interior portion of the beads or the entire interior portion of the beads. The size or the depth of the zones may be modulated by varying the reaction time and conditions. For example, in one preferred embodiment of the present invention, the first zone on the exterior portion of the beads is generated by carrying out the deprotection of Alloc protecting groups using a palladium complex and a silane compound for a certain duration of time. In another preferred embodiment, a zone in the interior portion of the beads is generated by selectively removing the Alloc protecting group within the interior portion of the beads by carrying out the deprotection reaction under a similar or different condition for another duration of time.

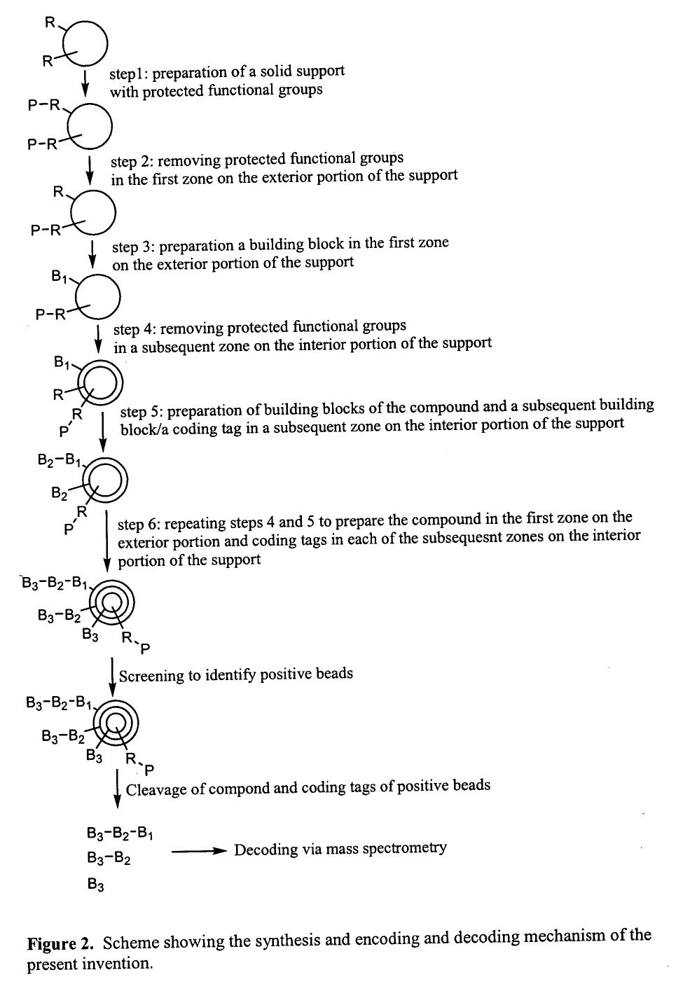

Using functionalized beads, the libraries of target compounds are prepared on the exterior portion of the beads while the coding tags or coding building blocks or truncated members of various lengths are prepared in each of subsequent zones on the interior portion of the beads. FIG. 2 illustrates the general concept of the synthesis and the coding methods of the present invention. The solid support has multiple reactive functional groups (R) in both the exterior portion and interior portion. In a preferred embodiment, the reactive functional group is an amino group. Through a protecting reaction, a reactive functional group is converted to a protected function group (P). In a preferred embodiment, a protected functional group (P) is an allyloxycarbonyl (Alloc) or a 9-fluorenylmethoxycarbonyl (Fmoc). Selective removal of the protected functional groups on the surface or in the first zone on the exterior portion of the beads re-generates the reactive functional groups (R), which further allow the formation of a building block (B₁) in the first zone on the exterior portion of the support. Similarly, the protected functional groups (P) in a subsequent zone on the interior portion of the beads can be removed selectively, which allow the formation of a coding tag/building block (B₂) for the target compound in the subsequent zone on the interior portion of the beads and target compound building blocks (B₂, B₁) on the exterior of the beads. Repeating the above process will generate a library of full-length target compounds on the outer surface/outer layer or in the first zone on the exterior portion of the support and coding tags/truncated ladder members in the subsequent zones on the interior potion of the support. Topologically, the process has created a reverse ladder molecular structure. In a preferred embodiment, the deprotection process is modulated such that a successive partial deprotection of the protected functional groups is accomplished. FIG. 2 demonstrates the preparation of a target compound with three building blocks (B₃, B₂, B₁) and two coding tags (B₃-B₂ and B₃). Alternatively, the method described in FIG. 2 can be used to prepare compounds having non-linear molecular structures, for example branched or dendritic molecules. When the compound has been prepared, the bead is subjected to a screening method to determine its activity. After screening, the coding tags in the positive beads are cleaved from the compound beads, and characterized by mass spectrometry. The structures of active compounds can be readily identified according to the exact molecular masses of the coding tags. The approach is generally applicable for the preparation of peptides, non-peptide oligomers, peptidomimetic and other small molecule libraries.

II. Method for the Preparation of Compound Libraries

A. Encoding the Libraries of Compounds

The present invention relates to methods for preparing libraries of compounds attached to solid supports, in which each solid support contains a single species of target compound; libraries of compounds prepared by the methods; and methods of identifying, and screening the compounds. Preferably, the library is one in which each solid support has a single species of target compound and the target compound is in a zone on the exterior portion of the support and the coding tags for the target compound are confined in the interior portion of the solid support.

In one embodiment, a method for preparing a library of compounds, comprising: a) providing a plurality of beads wherein each of said beads has an interior and an exterior portion and wherein each of said beads is divided into a plurality of zones extending from said exterior portion into said interior portion and wherein each of said zones consists of a plurality of reactive functional groups; b) contacting a first bead with a protective component such that said reactive functional groups of said first bead react with said protective component to afford a protected functional group; c) contacting said first bead with a deprotecting component such that said protected functional groups in a first zone on said exterior of said first bead revert to said reactive functional groups; d) contacting said first bead with a first reactive component such that said reactive functional groups in said first zone react with said first reactive component to afford a first building block of a compound precursor; e) contacting said first bead with a deprotecting component such that said protected functional groups in a subsequent zone on said interior of said first bead revert to said reactive functional groups; f) contacting said first bead with a subsequent reactive component such that said compound precursor reacts with said subsequent reactive component to afford a subsequent building block of said compound precursor, said reactive functional groups in said subsequent zone react with said subsequent reactive component to afford a coding tag, and any coding tag in any previous zone reacts with said subsequent reactive component to afford a coding tag additionally coding for said subsequent building block; g) repeating steps e)-f) until said first compound has been prepared; and h) subjecting additional beads to steps b)-g) with additional reactive components to prepare said library of compounds.

The libraries of compounds of the present invention are prepared on a solid support, preferably in the form of a bead. Beads which may be employed include cellulose beads, pore-glass beads, silica gel, polystyrene beads, particularly polystyrene beads cross-linked with divinylbenzene, grafted co-polymer beads such as polyethyleneglycol/polystyrene, polyacrylamide beads, latex beads, dimethylacrylamide beads, particularly cross-linked with N,N′-bis-acryloyl ethylene diamine and comprising N-t-butoxycarbonyl-β-alanyl-N′-acryloyl hexamethylene diamine, composites, such as glass particles coated with a hydrophobic polymer such as cross-linked polystyrene or a fluorinated ethylene polymer to which is grafted linear polystyrene; and the like. General reviews of useful solid supports (particles) that include a covalently-linked reactive functionality may be found in Atherton, et al., Prospectives in Peptide Chemistry, Karger, 101-117 (1981); Amamath, et al., Chem. Rev. 77:183-217 (1977); and Fridkin, The Peptides, Vol. 2, Chapter 3, Academic Press, Inc., (1979), pp. 333-363.

Libraries of the present invention include libraries of compounds bound to a solid support, as well as libraries of compounds that are not bound to a solid support. In a preferred embodiment, the present invention provides a library of compounds bound to a solid support and prepared by the method described above. In another preferred embodiment, the method of the present invention further comprises the following step: i) cleaving all or a portion of the compounds from each of the solid supports or beads. All or a portion of the compounds may be cleaved from the beads. Alternatively, all or a potion of the compounds together with all or a portion of the coding tags may be cleaved from the beads. In yet another preferred embodiment, the present invention provides a library of compounds wherein the compounds are not bound to a solid support.

The strategy of the present invention involves the formation of libraries of full-length target compounds residing on the exterior portion and the coding tags for the target compounds confined in the interior portion of the beads. In one embodiment, the beads contain reactive functional groups. The reactive functional groups include, but are not limited to hydroxyl, amino, thiol, aldehyde, halogen, nitro, cyano, amido, urea, carbonate, cabamate, isocyante, sulfone, sulfonate, sulfonamide, sulfoxide, amino acids, aryl, cycloalkyl, heteroalkyl, heteroaryl, and the like.

In one aspect of the invention, the beads are immersed in a solvent for a duration of time ranging from about 1 minutes to about 24 hours prior to subjecting the beads to the reaction. The solvent selected may be protic or aprotic solvents; strong polar solvents, such as methanol, ethanol, dimethyl sufoxide (DMSO), N,N-dimethylformamide (DMF), tetrahydofuran (THF), dichloromethane, ether, dioxane, chloroform; or less polar solvents, such as toluene, benzene, petroleum ether, pentane, hexanes; or water or a combination of listed solvents. The preferred solvent is methanol, ethanol, DMSO, DMF or water. The most preferred solvent is water.

In one embodiment, the reactive functional groups of the beads maybe unprotected or alternatively, the reactive functional groups are protected by contacting with a protective component to form protected functional groups. In a preferred embodiment, all the reactive functional groups on the beads are protected. The protective components of the present invention are those that are able to react with the reactive functional groups to form protected functional groups. The protective components include, but are not limited to those that are capable of forming hydroxyl protection groups, such as ethers, substituted methyl ethers, substituted ethyl ethers, substituted benzyl ethers, silyl ethers, esters and carbonates; carbonyl protecting groups, such as acyclic acetals and ketals, cyclic acetals and ketals, acyclic dithio acetals and ketals, and imines; thiol proteting groups, such as alkyl or benzyl silyl thioethers, silyl thioethers and thioesters; carboxyl protecting groups, such as esters, substituted methyl esters, 2-substituted ethyl esters, 2,6-dialkylphenyl esters, substituted benzyl esters, silyl esters and amides; amino protecting groups, such as methyl and ethyl carbamates, substitutes ethyl carbamates and amides. Preferred protective components include allyloxycarbonyl, acetyl, t-butyloxycarbonyl, benzoxymethyl, t-butoxymethyl, benzoyl, benzyloxycarbonyl, 9-fluorenylmethyl, 9-fluorenylmethoxycarbonyl, diphenylisopropylsilyl, di-t-butylmethylsily, 2-methoxyethoxymethyl, 9-(2-sulfo)fluorenylmethylcarbonyl, 2-chloro-3-indenylmethylcarbonyl (Climoc), Benz[f]inden-3-ylmethylcarbonyl (bimoc) and 1,1-dioxobenzo[b]thiophene-2-ylmethylcarbonyl (Bsmoc).

In a preferred embodiment of the present invention, a protected functional group reverts to a reactive functional group by contacting with a deprotecting component. The process may be effected, but not limited to photolytically, oxidatively, hydrolytically, thermolytically, reductively, electrochemically or enzymatically. The deprotecting components include, but not limited to acids, such as protic acids, Lewis acids, organic acids and inorganic acids in either gas, liquid or solid form; bases, such as Lewis bases, organic bases or inorganic bases in either gas, liquid, or solid form; organic salts or inorganic salts in gas, liquid, or solid form; neutral organic molecules; metals, metal particles, metal clusters, metal compounds or organometallic compounds. The metals may be main group metals, or transition metals or a combination thereof. The acids, bases, salts or neutral organic molecules can exist in homogeneous, heterogeneous or colloidal state or a combination thereof. In a preferred embodiment, the deprotecting component is a combination of transition metal complexes and neutral organic molecules. The transition metal complexes include complexes selected from group 3 to group 10 metals bound with various ligands such as hydrocarbons, phosphines, nitrogens, oxygens and sulfurs. Alternatively, the transition metal compounds can be group 11 and group 12 metal complexes. More preferably, the transition metal complexes are a group 10 metal compounds. In another preferred aspect, when the beads are first contacted with a deprotecting component, only the protected functional groups in the first zone on the exterior portion of the beads revert to the reactive functional groups. These reactive functional groups are in a range from about 1 to about 20% of the total substitution.

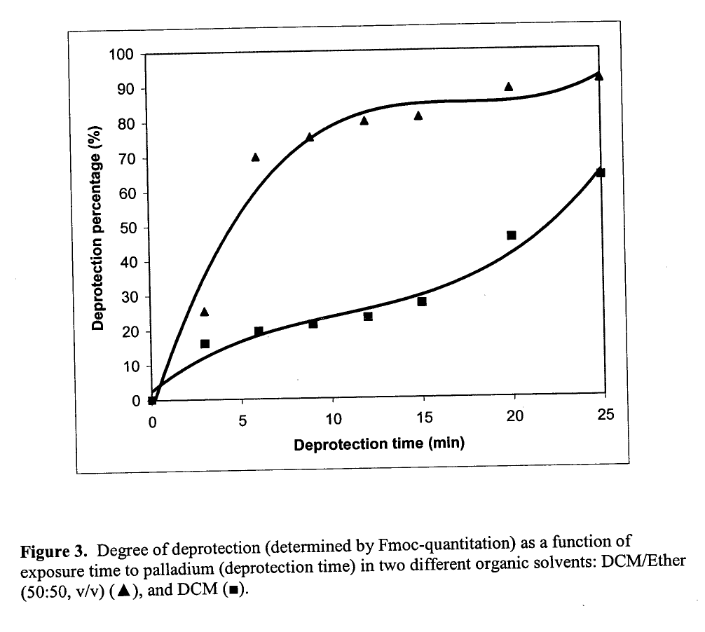

FIG. 3 shows solvent modulated deprotecting reactions when a deprotective component is contacted with a protected functional group. In one embodiment, the solvents used to carry out the reaction include, but not limited to more polar organic solvents, such as, methanol, ethanol, DMSO, DMF, THF, dichloromethane, ether, dioxane, chloroform; less polar organic solvents, such as toluene, benzene, petroleum ether, pentane, hexanes; water and a combination thereof. In a preferred embodiment, the reaction is carried out in a combination of solvents or more preferably in a mixture of chlorinated and non-chlorinated solvents, and even more preferably in a mixture of chlorinated solvent and a coordinated solvent, such as dichloromethane/THF. In another preferred embodiment, the deprotecting reaction can be modulated by varying the reaction time and the solvents such that the deprotecting component only react with the protective functional groups in each of the subsequent zones on the interior portion of the beads such that only these protective functional groups revert to reactive functional groups.

In yet another preferred embodiment, the deprotecting components react simultaneously with the protecting functional groups both in the first zone on the exterior portion of the beads and in each of the subsequent zones on the interior portion of the beads. In yet of another preferred embodiment, the deprotecting components react with the protecting groups in all the zones on both the exterior portion and the interior portion of the beads at the final step.

The compounds of the present invention are prepared using a variety of synthetic reactions, including, but not limited to, amine acylation, reductive alkylation, aromatic reduction, aromatic acylation, aromatic cyclization, aryl-aryl coupling, [3+2] cycloaddition, Mitsunobu reaction, nucleophilic aromatic substitution, sulfonylation, aromatic halide displacement, Michael addition, Wittig reaction, Knoevenagel condensation, reductive amination, Heck reaction, Stille reaction, Suzuki reaction, Aldol condensation, Claisen condensation, amino acid coupling, amide bond formation, acetal formation, Diels-Alder reaction, [2+2] cycloaddition, enamine formation, esterification, Friedel Crafts reaction, glycosylation, Grignard reaction, Homer-Emmons reaction, hydrolysis, imine formation, metathesis reaction, nucleophilic substitution, oxidation, Pictet-Spengler reaction, Sonogashira reaction, thiazolidine formation, thiourea formation and urea formation. The compounds of the present invention are prepared using a variety of reactive components. The reactive components of the present invention are those that are capable of reacting with the reactive functional groups to form a building block of a compound precursor. These include, but are not limited to, nucleophiles, electrophiles, radical generating agents, acylating agents, aldehydes, carboxylic acids, esters, alcohols, nitro, amino, carboxyl, aryl, heteroaryl, heteroalkyl, boronic acids, phosphorous ylides, alkane sulfonium, etc.

In a preferred embodiment, the subsequent reactive component reacts simultaneously with the reactive functional groups in each of the zones on both exterior portion and interior portion of the beads to form building blocks of the target compound on the exterior portion of the beads and the coding tags for the target compound in the interior portion of the beads such that to form a ladder structure with the target compound having a full-length of building blocks residing on the surface/outer zone of the exterior portion and the coding tags having truncated building blocks of lesser length or size in each of subsequent zones. In a more preferred embodiment, the difference in length between the intermediate compounds/coding tags each adjacent zones is one building block unit. For example, a coding tag in zone 1 is composed of five building blocks and a coding tag in an adjacent zone 2 has four building blocks.

In another embodiment, the resin beads are first derivatized with orthogonal protecting groups in the outer and inner regions separately. An orthogonal protecting group refers to one type of the protecting groups is capable of being removed in the presence of the other types of protecting groups. For example, in a preferred embodiment shown in Scheme 1, a Fmoc protecting group is used in the outer zone of the beads and an Alloc protecting group is used in the inner zones of the beads. A Fmoc protecting group can be selectively removed in the presence of an Alloc protecting group and an Alloc protecting group can be selectively removed in the presence of a Fmoc protecting group.

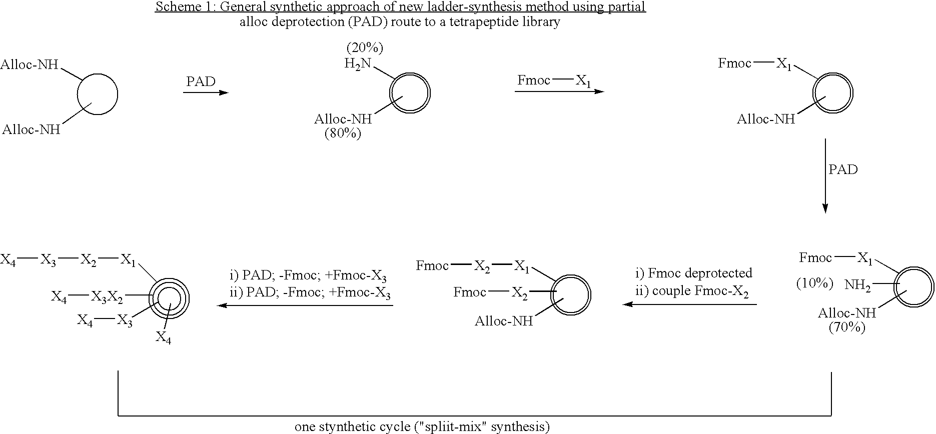

The present invention only uses one single building block for coupling during each coupling step, therefore avoiding the problems caused by the differential coupling rates of two different building blocks. Moreover, all the coding tags/truncated ladder members are confined to the bead interior, and only the full-length library compounds are displayed on the bead surface. As a result, the undesirable interference of ladder tags with the biological screening can be avoided. In addition, this method generates a reverse ladder that allows one to determine the peptide sequences by calculating mass differences between each two adjacent peaks in mass spectrometry.

In another aspect of the present invention, a method for preparing a library of compounds, comprising: a) contacting the beads prepared by the above methods with a first modifying agent to afford a modified compound and modified coding tags; and repeating step a) with additional modifying agents to prepare said library of compounds.

The modifying agents include, but not limited to reducing agents, such as hydrogen in homogeneous solution or on heterogeneous supports, various metal hydrides, alkli or alkaline metals alone or in combination with acids or bases and etc; oxidizing agents, such as ozone, oxygen, various metal oxides, organic peracids, inorganic acids or bases, halogens, DMSO, sodium or potassium permanganate, N-bromosuccinamide (NBS), N-chlorosuccinamide, NaOCl, organic or inorganic nitro compounds and etc; nucleophiles; electrophiles; organometallic compounds; and radical generating molecules. The reactions can be carried out either in aqueous solution or in the presence of organic solvents or mixed solvents.

In a preferred embodiment, the library of compounds of the present invention is prepared using a reducing agent for α-peptide according to Scheme 2. In a more preferred embodiment, a nitrosamine library is prepared and the modified coding tags are shown in Scheme 3. In another more preferred embodiment, aryliminoimidazolidine library is prepared and the modified coding tags are shown in Scheme 4. In yet another more preferred embodiment, aryliminoimidazolidine library is prepared and the modified coding tags are shown in Scheme 5.

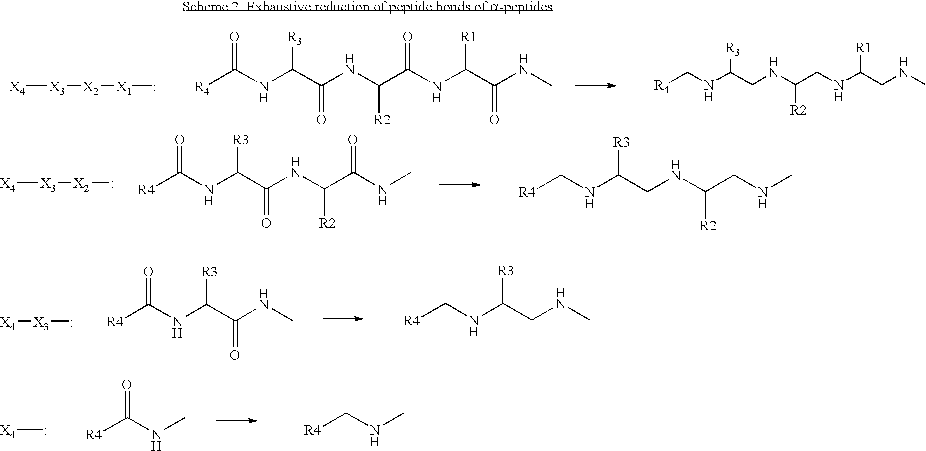

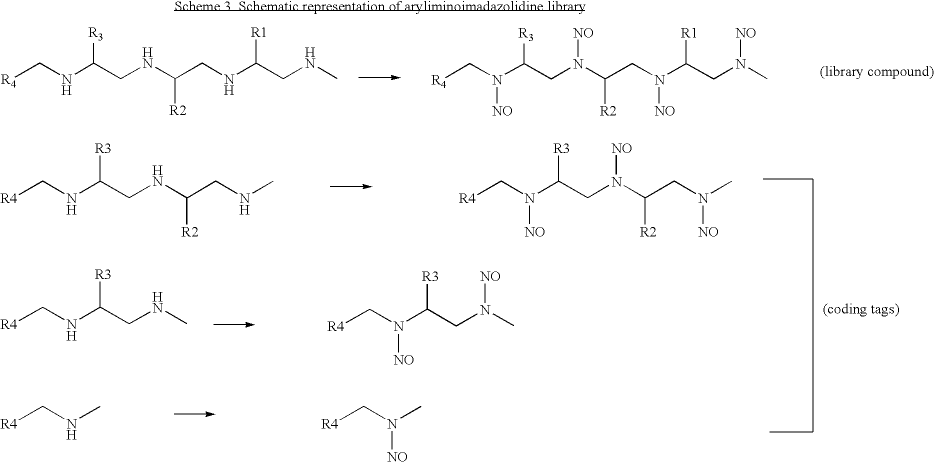

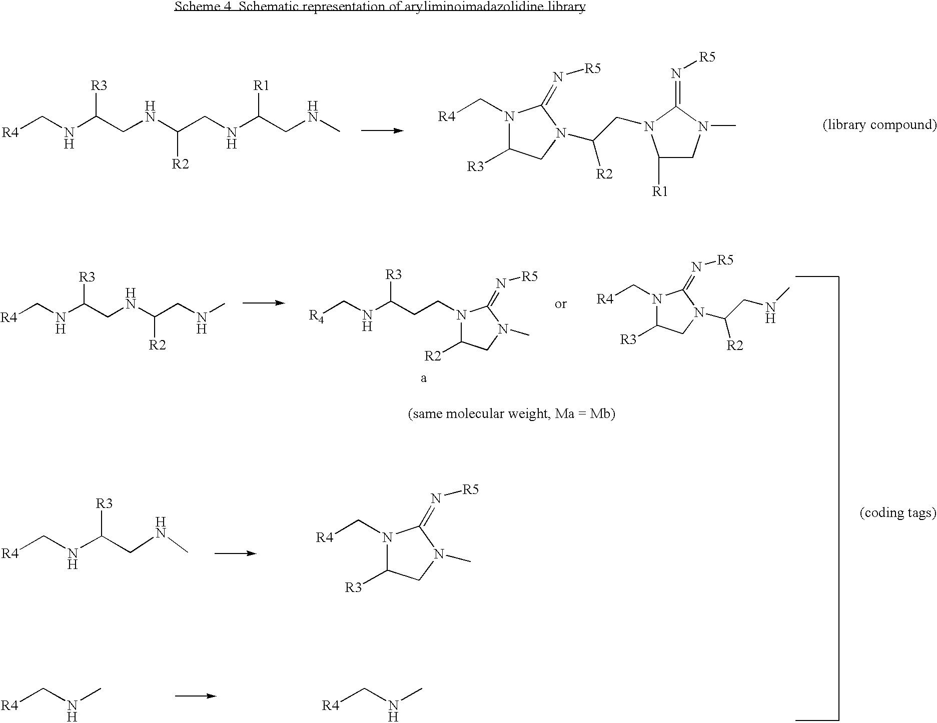

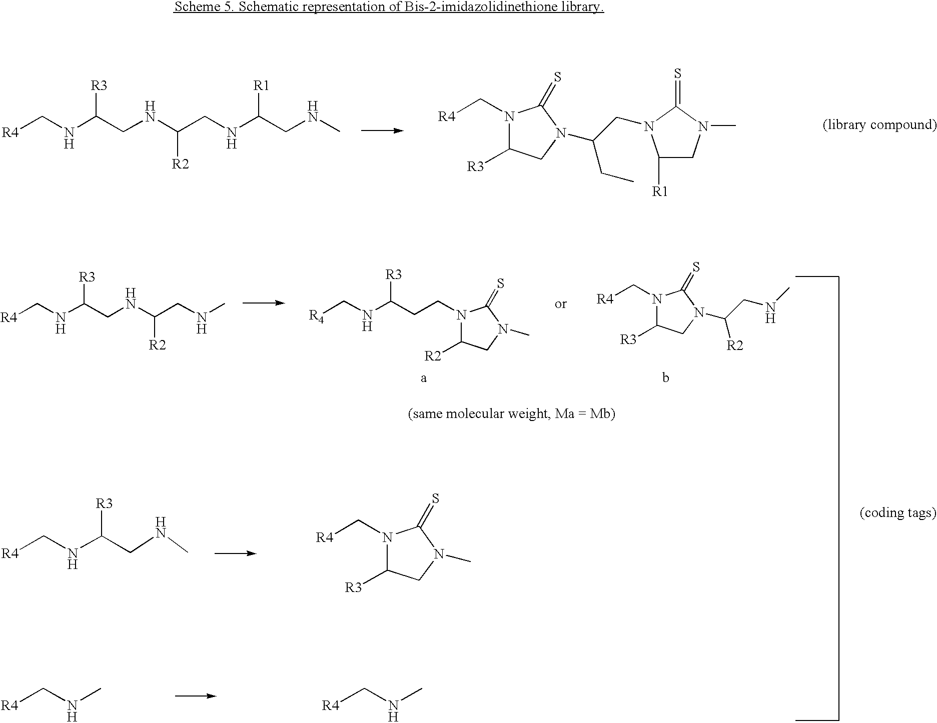

In a another preferred embodiment, the library of compounds of the present invention is prepared using a reducing agent for β-peptide according to Scheme 6. In a more preferred embodiment, a nitrosamine library is prepared and the modified coding tags are shown in Scheme 7. In another more preferred embodiment, aryliminoimidazolidine library is prepared and the modified coding tags are shown in Scheme 8. In yet another more preferred embodiment, aryliminoimidazolidine library is prepared and the modified coditags are shown in Scheme 9.

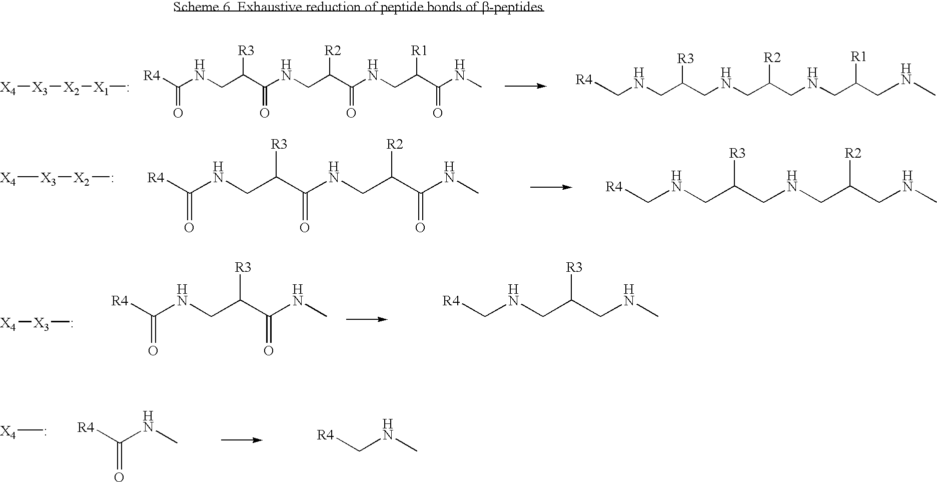

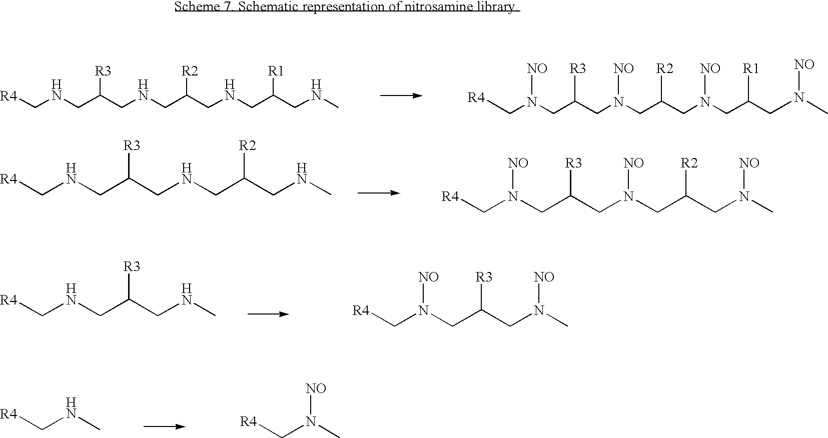

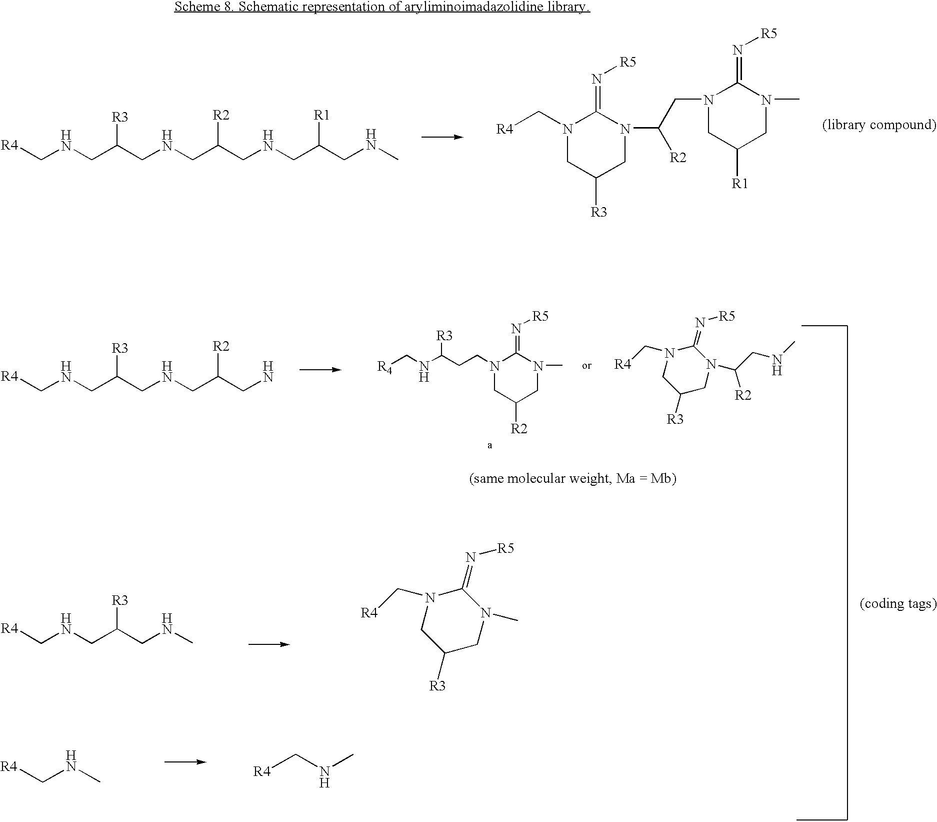

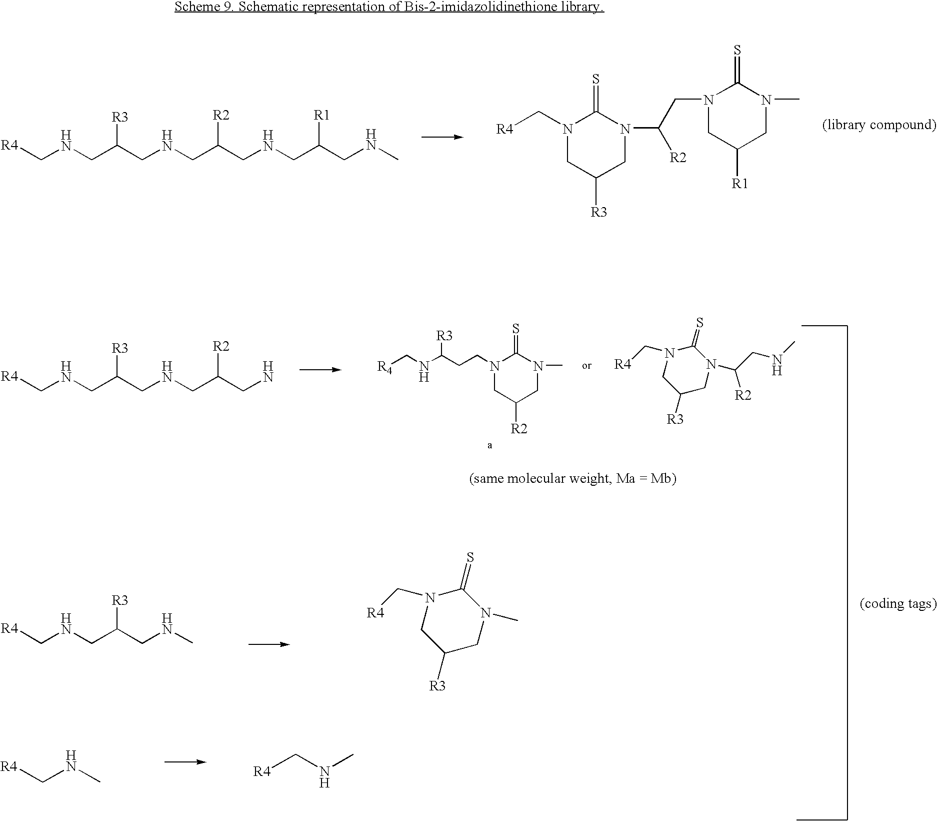

B. Encoding for Isobaric Building Blocks

Isobaric building blocks are molecular structures that have the same molecular weights, but different atomic connectivities. In one preferred embodiment, the synthetic scheme of the encoded library is essentially the same as that of the non-encoded library except for an extra encoding step applied to the bead aliquot that has just reacted with the designated encoded isobaric building block. This bead aliquot will undergo partial alloc deprotection (PAD), react with an coding tag (e.g., Gly), prior to mixing with the rest of the bead pool that has just undergone PAD. This extra step is applied to any designated isobaric building block (e.g., isoleucine for the isoleucine/leucine pair, and glutamine for glutamine/lysine pair) at any coupling cycle except the last. At the last coupling cycle, the bead aliquot that has just reacted with the designated encoded isobaric building block will undergo full Alloc deprotection, followed by coupling with another coding tag (e.g., Ac) rather than Gly.

In another preferred embodiment, the synthesis of the encoded tripeptide “ladder-synthesis” library is shown in Scheme 10. In each synthetic cycle, beads are first partially deprotected by the PAD approach, followed by a Fmoc-amino acid coupling. Then the aliquot of beads coupled with ‘A’ are partially deprotected, followed by coupling with a coding amino acid ‘a’ (e.g., Gly), the other aliquots of beads are pooled and partially deprotected. Since the terminus of ‘A’ is still Fmoc-protected after coupling (not shown in the scheme), the subsequent coding block (‘a’) can be anchored only to the exposed free N-termini. All beads are then combined together, Fmoc-deprotected and split for the next synthetic cycle. By repeating the synthetic cycle, the ladder segments generated in the preceding cycles are simultaneously extended with the current coupling of a residue. However, in the last cycle of library synthesis, the encoding is different. In this cycle, all beads are first split into two aliquots. 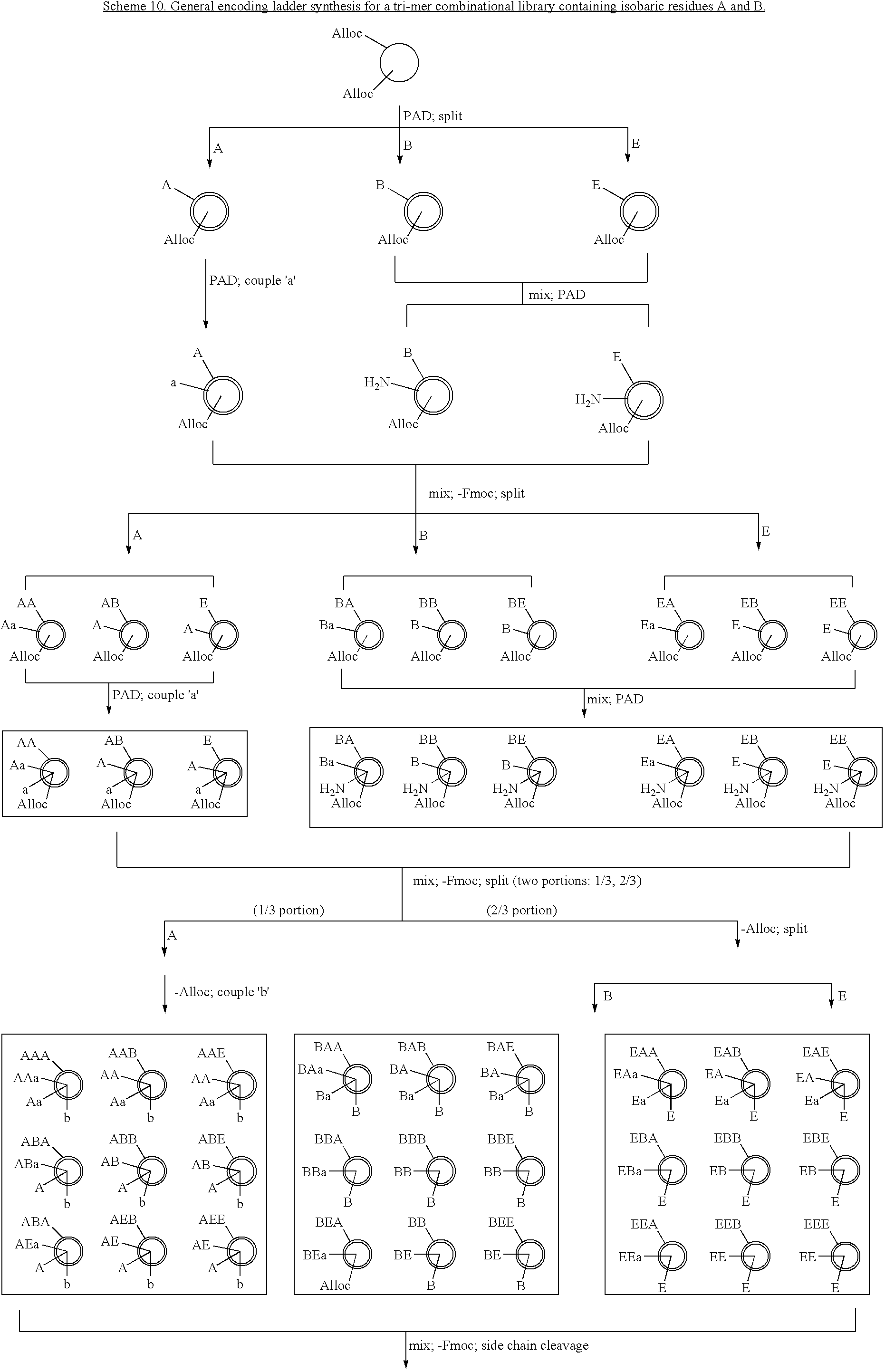 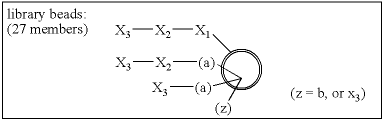
The small aliquot with ⅓ portion of the beads are coupled with ‘A’, and then thoroughly Alloc-deprotected, followed by acylation with a different coding block ‘b’ (e.g., Ac); the large aliquot with ⅔ portion of the beads are the bead interior (X₃X₂(a)-, X₃(a)- and z- (z=b when X₃ is the encoded residue, or z=X₃ when X₃ is not the encoded residue); ‘a’ in the brackets of the ladder members means that it may or may not be present in the corresponding ladder segments). Obviously, when z=X₃ and ‘a’ is not present in the second ladder product, X₃(a)- and z- will be degenerate as a single product (X₃-). In this case, the library compound actually has only three ladder members.

In yet another preferred embodiment, Fmoc-glycine is the preferred coding block (Fmoc-‘a’) because of its lowest molecular weight among all amino acids, making all ladder products on a single bead always appear in a fixed order in the mass spectrum (from low mass to high mass). The reason to use a different coding block (‘b’≠G) in the last cycle is to allow glycine as one of the library residues. ‘b’ can be a small organic acid such as acetic acid or propionic acid. For a library containing n residues, the synthetic cycle can be reiterated for n times to achieve the desired length of library sequence. In this case, the Alloc-deprotection time in each PAD step can be properly shortened to reserve sufficient Alloc groups in the bead interior for subsequent multistep liberations. If a library contains several pairs of isobaric residues, an identical coding block (e.g., glycine) can still be used to encode one of each pair because the coding tag is used only to reveal the presence of an encoded residue. But for libraries containing a residue with more than two isobaric isomers, one may use additional small coding blocks (e.g., Ala) to encode additional isomers.

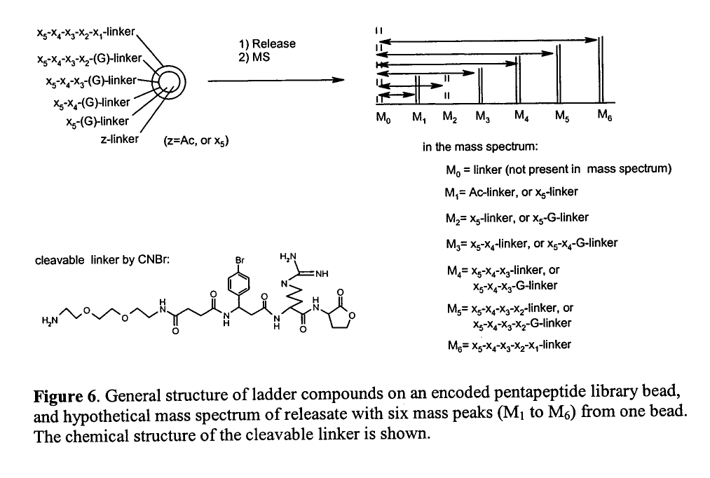

In yet still another preferred embodiment, using the above encoding strategy, synthesis of encoded pentapeptide library (X₄X₄X₃X₂X₁-bead) including two pairs of isobaric residues (isolucine/lucine and glutamine/lysine) can be accomplished. In the library, glutamine and isoleucine are encoded by glycine (G), but lysine and leucine are not. The general structure of ladder family on the pentapeptide library beads and hypothetical mass spectrum are illustrated in FIG. 6. Each bead carries six ladders: M₁ to M₆. In each ladder segment, the coding tag (‘G’) in the brackets means that it may or may not be present. It is important to keep in mind that (i) an extra encoding step is applied to the bead aliquot that has just reacted with the designated encoded isobaric building block. This bead aliquot undergoes PAD, reacts with an coding tag Fmoc-‘G’ prior to mixing with the rest of the bead pool that has just undergone PAD; and (ii) at the last coupling cycle, the bead aliquot that has just reacted with the designated encoded isobaric building block will undergo Alloc deprotection, followed by coupling with another coding tag, acetic acid (‘Ac’) rather than glycine. As a result, the presence of a coding tag (‘G’) in a ladder member signifies that an encoded residue (either isoleucine or glutamine) is present in the preceding ladder member corresponding to that position. However, when z=X₅- and G is absent in the ladder member of X₅-(G)-, M₁ and M₂ will be degenerate as one single peak in the mass spectrum. In this case, M₂=M₁, and there will be a total of only five, instead of six, MS peaks. All ladder members are released from a bead and analyzed by MALDI-TOF MS to determine the peptide sequence.

To illustrate how the encoding system works, the expected ladders generated from 4 different hypothetical beads isolated from the X₅X₄X₃X₂X₁-bead library, with isoleucine and glutamine as the designated encoded isobaric building block is shown in Table 1. Bead (I) has no isobaric building block, therefore M₂=M₁ and five standard reverse ladders are expected. For bead (II), the presence of ladder ‘X₅-a-linker’ and ‘X₅-I-linker’ indicates that X₄ is an encoded isobaric building block, in this case isoleucine. For bead (III), the presence of ‘b-linker’

TABLE 1
Expected ladder sequences released from four hypothetical beads, some with designated encoded isobaric
building blocks (I for I/L; Q for Q/K) at specific position, isolated from an OBOC combinatorial peptide
library (X₅X₄X₃X₂X₁-bead) generated by the new ladder-synthesis method shown in Scheme 3.^{a}

| | X₅X₄X₃X₂X₁- | X₅IX₃X₂X₁- | IX₄X₃X₂X₁- | X₅IX₃X₂Q- | I-IX₃QX₁- |
|---|---|---|---|---|---|
| | linker-bead | linker-bead | linker-bead | linker-bead | linker-bead |
| MS-peak | Bead (I) | Bead (II) | Bead (III) | Bead (IV) | Bead (V) |
| M₆ | X₅X₄X₃X₂X₁-linker | X₅IX₃X₂X₁-linker | IX₄X₃X₂X₁-linker | X₅IX₃X₂Q-linker | I-IX₃QX₁-linker |
| M₅ | X₅X₄X₃X₂-linker | X₅IX₃X₂-linker | IX₄X₃X₂-linker | X₅IX₃X₂a-linker | I-IX₃Q-linker |
| M₄ | X₅X₄X₃-linker | X₅IX₃-linker | IX₄X₃-linker | X₅IX₃-linker | I-IX₃a-linker |
| M₃ | X₅X₄-linker | X₅I-linker | IX₄-linker | X₅I-linker | I-I-linker |
| M₂ | (same as M₁) | X₅a-linker | I-linker | X₅a-linker | Ia-linker |
| M₁ | X₅-linker | X₅-linker | b-linker | X₅-linker | b-linker |
| M₀ | linker | linker | linker | linker | linker |

^{a}Encoding blocks: ‘a’ = G (glycme); ‘b’ = Ac (acetyl group). In the library, Q and I are encoded but their corresponding isomers K and L are not.

and ‘I-linker’ signifies that the last residue incorporated (i.e. the amino terminus) is an encoded isobaric building block, in this case isoleucine. For bead (IV), the presence of ‘X₅-a-linker’, ‘X₅-I-linker’, ‘X₅-I-X₃-X₂-a-linker’, and ‘X₅-I-X₃-X₂-Q-linker’ indicates that both X₄ and X₁ are the encoded isobaric building blocks, isoleucine and glutamine, respectively. For bead (V), the presence of ‘b-linker’ signifies that X₅ is an encoded isobaric building block; and the presence of ‘I-a-linker’, ‘I-I-linker’, ‘I-I-X₃-a-linker’, and ‘I-I-X₃-Q-linker’ indicates that both X₄ and X₂ are the encoded isobaric building blocks, isoleucine and glutamine, respectively.

C. Linkers

The solid supports of the present invention can also comprise linkers or an arrangement of linkers. As used herein, a linker refers to any molecule containing a chain of atoms, e.g., carbon, nitrogen, oxygen, sulfur, etc., that serves to link the molecules to be synthesized on the solid support with the solid support. The linker is usually attached to the support via a covalent bond, before initial synthesis on the support. The linker provides one or more sites for attachment of precursors of the molecules to be synthesized on the solid support. Linkers can be orthogonal or non-orthogonal linkers. Various linkers can be used to attach the precursors of molecules to be synthesized to the solid phase support. Examples of linkers include aminobutyric acid, aminocaproic acid, 7-aminoheptanoic acid, 8-aminocaprylic acid, lysine, iminodiacetic acid, polyoxyethylene, glutamic acid, etc. In a further embodiment, linkers can additionally comprise one or more β-alanines or other amino acids as spacers.

In another embodiment, the “safety-catch amide linker” (SCAL) (see Patek, M. and Lebl, M. 1991, Tetrahedron Letters 1991, 32, 3891; International Patent Publication WO 92/18144, published Oct. 29, 1992) is introduced to the solid support.

In addition to the linkers described above, selectively cleavable linkers can be employed. One example is the ultraviolet light sensitive linker, ONb, described by Barany and Albericio (J. Am. Chem. Soc. 1985, 107, 4936). Other examples of photocleavable linkers are found in Wang (J. Org. Chem. 1976, 41, 32), Hammer et al. (Int. J. Pept. Protein Res. 1990, 36, 31), and Kreib-Cordonier et al. in “Peptides—Chemistry, Structure and Biology”, Rivier and Marshall, eds., 1990, pp. 895-897). Landen (Methods Enzym. 1977, 47, 145) used aqueous formic acid to cleave Asp-Pro bonds; this approach has been used to characterize T-cell determinants in conjunction with the Geysen pin synthesis method (Van der Zee et al. 1989, Eur. J. Immunol. 191: 43-47). Other potential linkers cleavable under basic conditions include those based on p-(hydroxymethyl)benzoic acid (Atherton et al., J. Chem. Soc. Perkin I: 1981, 538-546) and hydroxyacetic acid (Baleaux et al., Int. J. Pept. Protein Res. 1986, 28: 22-28). Geysen et al. (J. Immunol. Methods, 1990, 134: 23-33; International Publication WO 90/09395) reported peptide cleavage by a diketopiperazine mechanism. Preferred diketopiperazine linkages are disclosed in U.S. Pat. No. 5,504,265, which is hereby incorporated by reference in its entirety.

Enzyme-cleavable linkers can also be useful. An enzyme can specifically cleave a linker that comprises a sequence that is recognized by the enzyme. Thus, linkers containing suitable peptide sequences can be cleaved by a protease and linkers containing suitable nucleotide sequences can be cleaved by an endonuclease.

In certain instances, one can derivatize a portion (e.g., 10-90%) of the available resin functional groups with a cleavable linker using certain reaction conditions, and the remaining of the resin functional groups with a linker which is stable to the cleavage conditions to ensure that enough material will remain on the resin after cleavage for further study. This arrangement is particularly preferred when there are no coding tags. Combinations of linkers cleavable under different reaction conditions can also be used to allow selective cleavage of molecules from a single solid support bead.

A solid phase support linker for use in the present invention can further comprise a molecule of interest, which can be further derivatized to give a molecular library. The pre-attached molecule can be selected according to the methods described herein, or can comprise a structure known to embody desired properties. In a preferred embodiment, the scaffold linker is an amino acid.

An ionization linker has been used to enhance ionization of poorly- or non-ionizable molecules (Carrasco, M. R., et al. Tetrahedron Lett. 1997, 38, 6331-6334). The linker also provides a mass shift which overcomes signal overlap with matrix molecules. To effectively decode each bead with mass spectrometry, the linker should meet the following four criteria. First, the linker must be inert to the chemical reactions for library synthesis and stable under the conditions used for various biological screening. Second, the linker should be highly sensitive to the ionization method so that the final coding tags with different structures can be readily detected. Third, its cleavage must be clean and efficient. Fourth, the linker should have excellent solubility in the extraction solvent. A simple peptide-like linker that meets the above four criteria has been designed and synthesized on solid phase using the standard Fmoc chemistry (Fields, G. B., et al. Int. J. Peptide Protein Res. 1990, 35, 161-214). In principle, any chemically cleavable or photosensitive linkers can be used as the cleavable part as long as they are compatible with the library synthesis and screening. Methionine is preferred due to its clean and specific cleavage by cyanogen bromide (CNBr), and the final homoserine lactone product (Gross, E. et al. J. Biol. Chem. 1962, 237, 1856-1860) is chemically stable. This cleavage method has been successfully applied to single-bead analysis of peptides (Youngquist, R. S. et al. Rapid Commun. Mass Spectrom. 1994, 8, 77-81; Youngquist, R. S., et al. J. Am. Chem. Soc. 1995, 117, 3900-3906). Two phenylalanines are coupled to the methionine to increase the molecular weight of the linker. Finally, a linear hydrophilic molecule is introduced to the linker to enhance solubility of the coding tag in the extraction solvent (50% acetonitrile/water). The whole linker has excellent chemical stability, and is very suitable for MALDI-FTMS detection. The oxygen atoms, the amide bonds and the side chain of phenylalanines in the linker allow efficient formation of primarily sodiated species, and therefore provide efficient ionization.

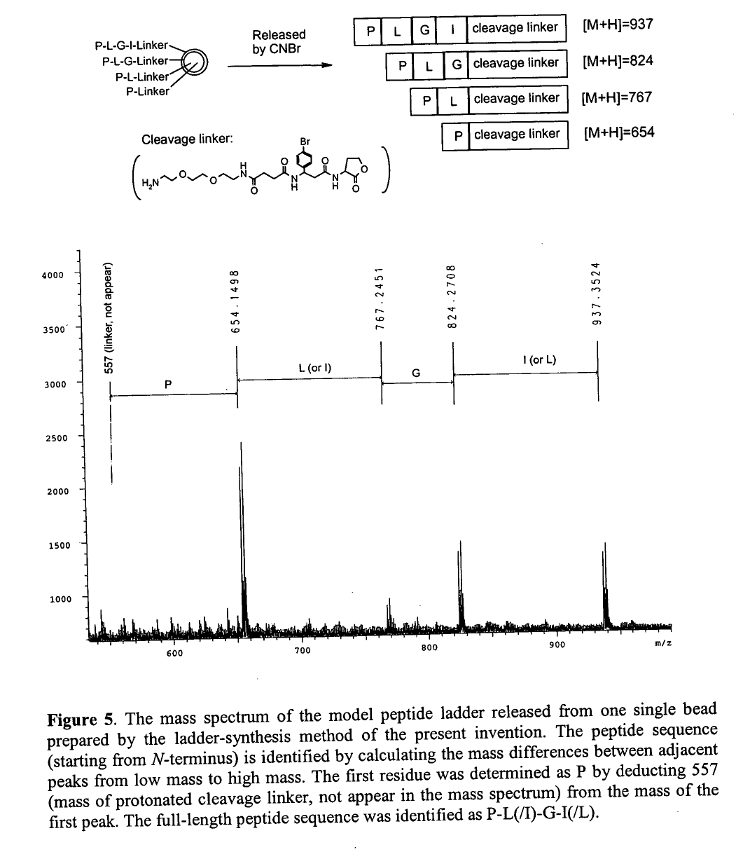

In one embodiment, each of the reactive functional groups is individually attached to the beads through a cleavable linker and then assembled a sequence of building blocks, which can be cleaved for MS sequence analysis (FIGS. 5 and 6).

In another embodiment, the linkers employed in the present invention are orthogonal linkers. One type of linkers may be selectively cleaved in the presence of other types of linkers. For example, one type of linkers may be removed under the same or similar or a different reaction condition from the one employed to cleave other types of linkers.

D. Solid Supports

A separate phase support suitable for use in the present invention is characterized by the following properties: (1) insolubility in liquid phases used for synthesis or screening; (2) capable of mobility in three dimensions independent of all other supports; (3) containing many copies of each of the synthetic test compound and, if present, the coding sequence attached to the support; (4) compatibility with screening assay conditions; and (5) being inert to the reaction conditions for synthesis of a test compound. A preferred support also has reactive functional groups, including, but not limited to, hydroxyl, carboxyl, amino, thiol, aldehyde, halogen, nitro, cyano, amido, urea, carbonate, carbamate, isocyanate, sulfone, sulfonate, sulfonamide, sulfoxide, etc., for attaching a subunit which is a precursor to each of the synthetic test compound and coding building blocks, or for attaching a linker which contains one or more reactive groups for the attachment of the monomer or other subunit precursor.

As used herein, separate phase support is not limited to a specific type of support. Rather a large number of supports are available and are known to one of ordinary skill in the art. In a preferred aspect, the separate phase support is a solid phase support, although the present invention encompasses the use of semi-solids, such as aerogels and hydrogels. Solid phase supports include silica gels, resins, derivatized plastic films, glass beads, cotton, plastic beads, alumina gels, polysaccharides such as Sepharose and the like, etc. A suitable solid phase support can be selected on the basis of desired end use and suitability for various synthetic protocols. For example, in polyamide synthesis, useful solid phase support can be resins such as polystyrene (e.g., PAM-resin obtained from Bachem Inc., Peninsula Laboratories, etc.), POLYHIPE™ resin (obtained from Aminotech, Canada), polyamide resin (obtained from Peninsula Laboratories), polystyrene resin grafted with polyethylene glycol (TentaGel™, Rapp Polymere, Tubingen, Germany), polydimethyl-acrylamide resin (available from Milligen/Biosearch, California), or PEGA beads (obtained from Polymer Laboratories). Preferred solid phase synthesis supports for specific syntheses are described below. Thus, each resin bead is functionalized to contain both synthetic test compound and the corresponding coding structures. In a variation of this approach, the synthetic test compound and coding building blocks are attached to the solid support through linkers such as those described below. One of skill in the art will recognize that while many types of solid supports are useful in the present invention, topologically segregated solid supports are particularly useful.

Topology of Solid Supports

A variety of approaches for topologically separating the synthetic test compound and coding tags on a solid support in order to generate libraries are useful.

Topologically separating the synthetic test compound and the coding tag refers to the separation in space on a support. For example, if the support is a resin bead, separation can be between the surface and the interior of the resin bead of a significant number of the ligand-candidate molecules from a significant number of the coding tags. Preferably, the surface of the support contains primarily synthetic test compound molecules and very few coding tags. More preferably, the surface of the support contains greater than 90% synthetic test compound and less than 10% coding tags. Even more preferably, the surface of the support contains greater than 99% synthetic test compound molecules and less than 1% coding tags; most preferably, it contains more than 99.9% synthetic test compound and less than 0.1% coding tags. The advantage of such an arrangement is that interference of the coding tag in a binding screening assay is limited. It is not necessary that the topological area that contains the coding tag, i.e., the interior of a resin bead, be free of the synthetic test compound.

As discussed above, the coding tags are optionally segregated in the interior of the support particle. However, coding tags can also be segregated to the surface of a support particle, or to one side of a support particle.

One general approach for the topological separation of synthetic test compound from coding tags involves the selective derivatization of reactive sites on the support based on the differential accessibility of the coupling sites to reagents and solvents. For example, regions of low accessibility in a resin bead are the interior of the bead, e.g., various channels and other cavities. The surface of a resin bead, which is in contact with the molecules of the solution in which the bead is suspended, is a region of relatively high accessibility. Methods for effecting the selective linkage of coding functional groups and scaffolds to a suitable solid phase support include, but are not limited to, the following.

(i) Selective Derivatization of Solid Support Surfaces Via Controlled Photolysis

Two approaches can be used. In one, a functionalized solid support is protected with a photocleavable protecting group, e.g., nitroveratryloxycarbonyl (Nvoc) (Patchornik et al. J. Am. Chem. Soc. 1970, 92, 6333). The Nvoc-derivatized support particles are arranged in a monolayer formation on a suitable surface. The monolayer is photolyzed using light of controlled intensity so that the area of the bead most likely to be deprotected by light will be the area of the bead in most direct contact with the light, i.e., the exterior surface of the bead. The resulting partially deprotected beads are washed thoroughly and reacted with a scaffold containing a light-stable protecting group. Following the reaction with the scaffold, the beads are subjected to quantitative photolysis to remove the remaining light-sensitive protecting groups, thus exposing functional groups in less light-accessible environments, e.g., the interior of a resin bead. After this quantitative photolysis, the support particles are further derivatized with an orthogonally-protected coding functional group, e.g., Fmoc-protected amino acid. The resulting solid support bead will ultimately contain synthetic test compound segregated primarily on the exterior surface and coding tags located in the interior of the solid phase support bead.

An alternative photolytic technique for segregating coding building blocks and synthetic test compound on a support involves derivatizing the support with a branched linker, one branch of which is photocleavable, and attaching the coding functional groups to the photosensitive branch of the linker. After completion of the synthesis, the support beads are arranged in a monolayer formation and photolyzed as described above. This photolysis provides beads which contain patches of synthetic test compound for selective screening with minimal interference from the coding building blocks.

(ii) Selective Derivatization of Solid Support Surfaces Using Chemical or Biochemical Approaches

The efficacy of these chemical and biochemical derivatizations depends on the ability of exterior surface functional groups, which are exposed, to react faster than other groups in the interior which are not exposed. It has been observed, for example, that antibodies cannot bind to peptide ligands in the interior of a non-porous resin solid phase support. Therefore, using differences in steric hindrance imposed by the structure of the support or by modulating the swelling of a bead through choice of reaction solvent, reactive groups on the exterior of the bead that are accessible to macromolecules or certain reagents can be reacted selectively relative to reactive groups in the interior of the bead. Therefore, the reactive groups in the exterior of the bead can be modified for the synthesis of the synthetic test compound, while interior reactive groups can be modified for preparation of the coding tags, or both the coding tags and synthetic test compound. Since the number of reactive groups inside a resin bead is much larger than the number of groups on the outer surface, the actual number of coding tags will be very large, providing enough coding tags for accurate mass spectral analysis, and thus the decoding of the structure of the synthetic test compound. A variety of chemical and biochemical approaches are contemplated including the following:

(a) Use of Polymeric Deprotecting Agents to Selectively Deprotect Parts of the Exterior of a Solid Support Bead Carrying Protected Functional Groups

The deprotected functional groups are used as anchors for the scaffold. The functional groups which remain protected are subsequently deprotected using a nonpolymeric deprotecting agent and used as anchors for the attachment of the coding functional groups. In a specific embodiment, this method involves use of enzymes to selectively activate groups located on the exterior of beads which have been derivatized with a suitable enzyme substrate. Due to their size, enzymes are excluded from the interior of the bead. In an example, infra, an enzyme completely removes a substrate from the surface of a resin bead, without significantly affecting the total amount of substrate attached to the bead, i.e., the interior of the bead. The removal of substrate exposes, and thus activates, a reactive site on the bead. The enzyme-modified groups of the solid support are used to anchor the scaffold and those groups that escaped modification are used to anchor the majority of the coding functional groups.

(b) Use of a Polymeric Protecting Group to Selectively Block Exposed Unprotected Functional Groups on the Exterior of a Support Bead

The unprotected functional groups in the interior of the support are used to anchor the coding functional groups. The remaining protected functional groups are then deprotected and used as anchors for the scaffolds of the library.

(c) Creating a Different State in the Interior of the Bead

Through the judicious selection of solvents, it is possible to swell the beads with one solvent, which is subsequently frozen, and then add the beads to a second solvent at a low temperature. For example, by freezing water inside the beads, then reacting the beads in an organic solvent at low temperature, the water in the interior of the bead remains frozen. Thus the surface of the bead, but not the interior, can be selectively reacted.

(d) Use of a Biphasic Solvent Environment

In a similar fashion to method (c) above, the beads are first swelled with an aqueous solvent, followed by derivatization of the beads in an appropriate organic solvent such that the water in the interior of the bead remains there. In this manner, only the functional groups. on the outside of the bead (those not in the aqueous solvent) are derivatized (Liu, R. et al. J. of the Am. Chem. Soc. 2002, 124, 7678).

E. Split-Mix Methodology

In a preferred embodiment, the library of compounds is prepared via a split-mix or split-pool methodology. In a further preferred embodiment, the present invention provides a method for preparing a library of compounds via the split-mix methodology, comprising: a) providing a plurality of beads, wherein each said beads has an interior portion and an exterior portion and wherein each of said beads is divided into a plurality of zones extending from said exterior portion into said interior portion and wherein each of said zones consists of a plurality of reactive functional groups; b) contacting each said beads with a protective component; c) contacting each said beads with a deprotecting component; d) splitting the beads into two or more separate pools; e) contacting the first reactive components with one or more first reactive functional groups in the two or more separate pools such that a first reactive functional group reacts with one of the first reactive components to afford a first building block, and a first coding functional group reacts with one of the first reactive components to afford a first coding building block, wherein the contacting step yields subsequent compound precursors; f) mixing the subsequent synthesis templates from the two or more separate pools into a single pool; g) splitting the subsequent compound precursors into two or more separate pools; h) contacting the subsequent compound precursors in the two or more separate pools with a successive reactive component such that a subsequent reactive functional group reacts with the successive reactive component to afford a subsequent building block, and a subsequent coding functional group reacts with the successive reactive component to afford a subsequent coding building block, wherein the contacting step yields further compound precusors; i) repeating steps f)-h), wherein the further compound precursors of step h) become the subsequent compound precursors of step f), until the library of compounds has been prepared.

The synthesis of libraries of synthetic test compound via a split-mix methodology comprises repeating the following steps: (i) dividing the selected beads into a number of portions which is at least equal to the number of different subunits to be linked; (ii) chemically linking one and only one of the subunits of the synthetic compound with one and only one of the portions of the solid support from step (i), preferably making certain that the chemical link-forming reaction is driven to completion to the fullest extent possible; (iii) thoroughly mixing the solid support portions containing the growing synthetic test compound; (iv) repeating steps (i) through (iii) a number of times equal to the number of subunits in each of the synthetic test compound of the desired library, thus growing the synthetic test compound; (v) removing any protecting groups that were used during the assembly of the synthetic test compound on the solid support.

Preferably, the coding building blocks are synthesized in parallel with the synthetic test compound. In this instance, before or after linking the subunit of the synthetic test compound to the support in step (ii), one coding building block, that correspond(s) to the added subunit of the synthetic test compound, is separately linked to the solid support, such that a unique structural code, corresponding to the structure of the growing synthetic test compound, is created on each support. It can be readily appreciated that if an encoded library is prepared, synthesis of the coding unit must precede the mixing step, (iii).

The repetition of steps (i)-(iii) (see step (iv)) will naturally result in growing the synthetic test compound and, if the process is modified to include synthesis of coding building blocks, a coding building block in parallel with each step of the test compound.

In one embodiment, enough support particles are used so that there is a high probability that every possible structure of the synthetic test compound is present in the library. Such a library is referred to as a “complete” library. To ensure a high probability of representation of every structure requires use of a number of supports in excess, e.g., by five-fold, twenty-fold, etc., according to statistics, such as Poisson statistics, of the number of possible species of compounds. In another embodiment, especially where the number of possible structures exceeds the number of supports, not every possible structure is represented in the library. Such “incomplete” libraries are also very useful.

F. Screening Methods

In addition to providing libraries of a great variety of chemical structures as synthetic test compounds, and methods of synthesis thereof, the present invention further comprises a method for identifying a compound of the present invention that binds to a target, wherein the compound is attached to a solid support, the method comprising: a) contacting the compound prepared according to the method described above with the target; and b) determining the functional effect of the compound upon the target. In one embodiment, the compounds are attached to the solid support via linkers. The linkers may be the same types or different types. The linkers may be orthogonal or non-orthogonal. One type of linkers may be selectively cleaved in the presence of other types of linkers. In a preferred embodiment, the target of the present invention is a biological target. In other embodiments, the target can be synthetic in nature, such as a photogenic receptor or other material with an intensity physical property.

In another embodiment, the present invention provides a method for identifying a compound of the present invention that binds to a target, wherein all the compounds or a portion of the compounds are cleaved from the beads, the method comprising: a) contacting the compound prepared according to the method described above with the target; and b) determining the functional effect of the compound upon the target. In a preferred embodiment, the target of the present invention is a biological target. In other embodiments, the target can be synthetic in nature, such as a photogenic receptor or other material with an intensity physical property.

The methods of screening the test compounds of a library of the present invention identify ligands within the library that demonstrate a biological activity of interest, such as binding, stimulation, inhibition, toxicity, taste, etc. Other libraries can be screened according to the methods described infra for enzyme activity, enzyme inhibitory activity, and chemical and physical properties of interest. Many screening assays are well known in the art; numerous screening assays are also described in U.S. Pat. No. 5,650,489.

The ligands discovered during an initial screening may not be the optimal ligands. In fact, it is often preferable to synthesize a second library based on the structures of the ligands selected during the first screening. In this way, one may be able to identify ligands of higher activity.

G. Decoding the Library

There are two general approaches to determining the structure of a test compound: the structure of the compound may be directly analyzed by conventional techniques, e.g., nuclear magnetic resonance or mass spectrometry; alternatively, a second molecule or group of molecules can be synthesized during the construction of the library such that the structure(s) of the second molecular species unambiguously indicates (encodes) the structure of the test compound attached to the same support. By this second technique, the structure of compounds that are not themselves amenable to analyzing can be readily determined.

In one embodiment of the present invention, the method of the present invention for identifying a compound prepared comprising: a) cleaving each of the compounds and each of the coding tags from the beads; b) subjecting the compounds and the coding tags to mass spectral analysis; and c) calculating the mass difference between the mass of a compound peak or a coding tag peak and a peak corresponding to a linker in order to identify the compound. In a preferred embodiment, the analysis is carried out via mass spectrometry. one of skill in the art can envision other analytical tools that are useful in the present invention.

Decoding is accomplished by cleaving all the coding tags at once and analyzing the releasates by mass spectrometry. In a preferred embodiment, matrix-assisted laser desorption/ionization Fourier transform mass spectrometry (MALDI-FTMS) is used due to its high mass resolution, accuracy and sensitivity. A hydrophilic linker (-linker-Phe-Phe-Met-) that links the coding building blocks with the solid support (resin bead) is designed to facilitate mass spectrometry analysis. Methionine is stable to many chemical reactions, but it can be readily cleaved by cyanogen bromide (CNBr). Its cleavage is very reliable and specific, and offers clean products, which are suitable to single-bead analysis. Two phenylalanines are introduced into the linker to increase the molecular weight of the final cleavage products, so that their signals can be easily distinguished from those of matrix and impurities. An additional hydrophilic linker is selected to enhance the solubility of the final cleaved products in the extraction solvent (50% acetonitrile/water). The whole linker has excellent chemical stability, and is very suitable for MALDI-FTMS detection.

Using this method, it is possible to detect several coding tags in the inner core (about 40-80% substitution in total) of a single bead. Because only the molecular mass of the coding tags is needed to identify the structure of library compound, a very small amount of a coding tag is sufficient for MALDI-FTMS detection. Considering a library based on a scaffold with four diversities, if 100 different reactive components are used in each synthetic step, a library containing 100⁴=100,000,000 compounds will be generated, while the total number of coding tag structures required is only 400. Because of the high precision and sensitivity of MALDI-FTMS, it is not difficult to accurately identify each of the 400 different building blocks used in the library synthesis. Since each coding functional group has only one functional group, the chemical structure of the final coding building blocks is very simple. Furthermore, all the coding tags are located in the interior of the bead, and each of them constitutes only about 10% equivalent of the whole bead, it is anticipated that this encoding method will have minimal effect on biological screening.

### EXAMPLES

### Example 1

### General Methods

(1) Coupling completeness and deprotection are tested by Kaiser test or standard chloranil test (Vojkovsky, T., Peptide Res. 1995, 8, 236-237; Ma\check{r}ík, J. et al., Tetrahedron Lett. 2003, 44, 4319-4320) (solution A: 2% of acetaldehyde in DMF; solution B: 2% of tetrachloro-1,4-benzoquinone in DMF). (2) For Fmoc deprotection, beads are incubated with 25% piperidine solution in DMF for 10 min twice and then thoroughly washed with MeOH, DCM and DMF three times each. (3) For thorough Alloc-deprotection (Thieriet, N. et al.,. Tetrahedron Lett. 1997, 38, 7275-7278; Orain, D. et al., J. Comb. Chem. 2002, 4, 1-16), beads are shaken with 0.24 equiv of Pd(PPh₃)₄ and 20 equiv of PhSiH₃ in DCM for 1 h under argon and then washed with DCM and DMF three times each. (4) For partial Alloc-deprotection, beads (protected with Alloc) are swollen in water for 3-4 h (or 24 h for the first bilayer segregation). After draining water, a solution of 0.24 equiv of Pd(PPh₃)₄ and 20 equiv of PhSiH₃ in DCM (40 mL) is rapidly added into the bead container and vigorously shaken for a short time as desired. The beads are washed with DCM and DMF three times each. (5) For the chemical release of compounds from beads, the compound-bound beads are thoroughly washed and then individually transferred into 200 μL polypropylene microcentrifuge tubes in ethanol under a microscope. Cyanogen bromide (20 mg/mL, 20 μL) in 70% formic acid is added into each tube and stored at room temperature overnight. All samples are lyophilized to dryness, and submitted to MALDI-TOF-MS analysis. (6) For MALDI-TOF-MS analysis, samples are analyzed with a Bruker Biflex III MALDI-TOF mass spectrometer (Bruker-Franzen Analytik, Bremen, Germany) equipped with a pulsed N₂ laser (337 nm), a delayed extraction ion source and a reflectron. 0.5 μL of the peptide aliquot is mixed with an equal volume of matrix solution (a saturated solution of α-cyano-4-hydroxycinnamic acid in 0.1% TFA-acetonitrile (50:50) and applied to the target. The mass spectra are acquired in the reflectron mode.

### Example 2

### Quantitation of Alloc-Deprotection Percentage

TentaGel beads (1.0 g) were protected with Alloc-OSu (3 equiv)/DIPEA (6 equiv) for 1 h. Upon washing with DMF and MeOH, the beads were then swollen in water for 24 h, then evenly divided into two portions (A, B). The portion A was equally split into 7 aliquots. For each aliquot of beads, after draining water, a solution of Pd(PPh₃)₄ (0.24 equiv)/PhSiH₃ (20 equiv) in DCM (20 mL) was rapidly added into the bead container and vigorously shaken for a different time. Seven aliquots of beads were shaken for 3 min, 6 min, 9 min, 12 min, 15 min, 20 min, 25 min, respectively. After draining the solution, the beads were washed with DCM and DMF three times each, and protected with Fmoc-OSu (3 equiv)/DIPEA (6 equiv) for 1 h. After thorough washing with DMF and MeOH, each aliquot of beads was dried in vacuo for 72 h and 37 mg of dry beads were weighed out for Fmoc quantitation. The portion B of beads was treated in DCM/ether (50:50, v/v) by the same procedure as mentioned above. Each group of beads was incubated with 20 mL of 25% piperidine in DMF for 2 h. The solution was detected by UV spectrometry at 280 nm (Fields, G. B. et al., Int. J. Pept. Protein Res. 1990, 35, 161-214). The degree of deprotection as a function of exposure time to palladium in two different organic solvents is shown in FIG. 3.

### Example 3

### Slicing of FITC-Labeled Bilayer Bead

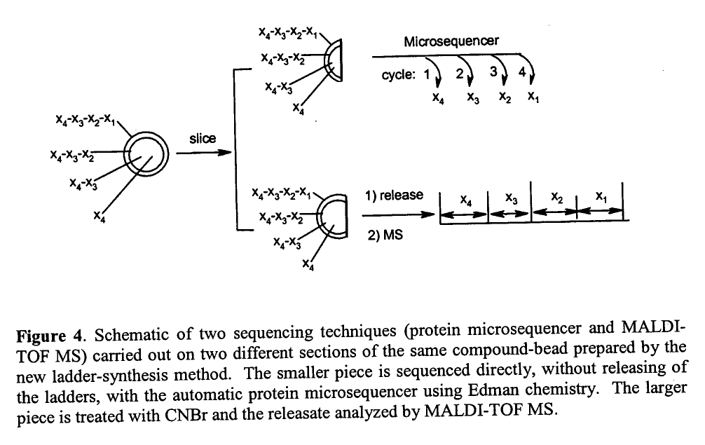

Alloc-protected beads (0.1 g) were swollen in water for 24 h and deprotected in DCM by the general method (4) for 7 min. After washing, the beads reacted with fluorescein-5-isothiocyanate (3 equiv)/DIPEA (6 equiv) for 5 h. Upon thorough washing, some beads were randomly picked and the beads were carefully cross-sectioned by using two scalpels under a dissecting microscope. The middle piece of one bead was carefully transferred into a petri dish with ethanol and visualized under a fluorescent microscope. FIG. 4 is a schematic showing of two sequencing techniques (protein microsequencer and MALDI-TOF MS) carried out on two different sections of the same compound-bead prepared by the new ladder-synthesis method.

### Example 4

### Ladder Synthesis of P-L-G-I Peptide

TentaGel beads (0.4 g) were swollen in DMF overnight, followed by successive coupling with Fmoc-Met, Fmoc-3-(4-bromophenyl)-β-alanine and Fmoc-2,2′-ethylenedioxy-bis (ethylamine) monosuccinamide in presence of HOBt (3 equiv) and DIC (3 equiv) by using Fmoc chemistry. After Fmoc-deprotection, the beads were protected with Alloc-OSu (3 equiv)/DIPEA (6 equiv) for 1 h. The beads were treated for 7 min by the general method (4) and coupled with Fmoc-isoleucine (3 equiv), HOBt (3 equiv) and DIC (3 equiv) for 2 h. The resulting beads were thoroughly washed and then treated by the same method for 4 min. After Fmoc-deprotection, the beads were coupling with Fmoc-Gly (3 equiv), HOBt (3 equiv) and DIC (3 equiv). By repeating the same procedure, the beads were coupled with Fmoc-leucine (3 equiv)/HOBt (3 equiv)/DIC (3 equiv). Lastly, the beads were thoroughly Alloc-deprotection and then Fmoc-deprotected, followed by coupling with Fmoc-Pro (3 equiv)/HOBt (3 equiv)/DIC (3 equiv). After Fmoc-deprotection, the beads were thoroughly washed and stored in 70% ethanol. FIG. 5 shows the mass spectrum of the model peptide (P-L-G-I) ladder released from one single bead prepared by the new ladder-synthesis method of the present invention.

### Example 5

### Encoded Ladder Synthesis of Pentapeptide Library

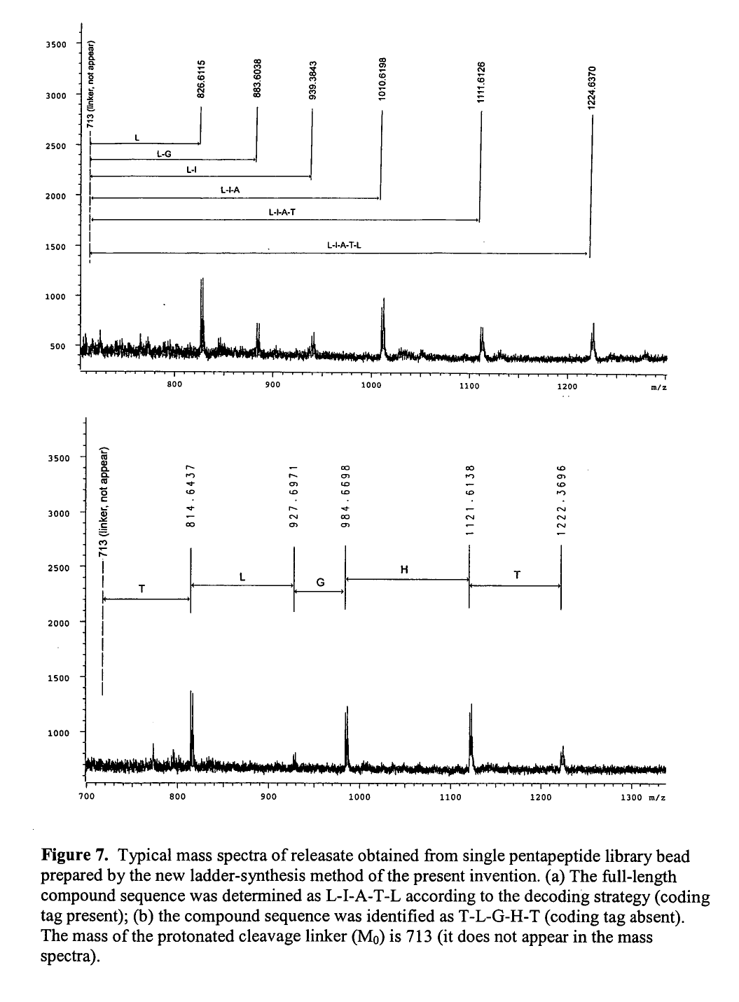

Beads (1.7 g) were swollen in DMF overnight and then successively coupled with Fmoc-Met, Fmoc-Arg, Fmoc-3-(4-bromophenyl)-β-alanine and Fmoc-2,2′-ethylenedioxy-bis (ethylamine) monosuccinamide by using Fmoc chemistry. After removing Fmoc, the beads were protected with Alloc-OSu (3 equiv)/DIPEA (6 equiv) for 1 h. In the first synthesis cycle, the beads were Alloc-deprotected for 7 min by the general method (4) and split into 17 aliquots. Each aliquot of beads was coupled by a Fmoc-protected amino acid (3 equiv) in the presence of HOBt (3 equiv) and DIC (3 equiv). The aliquot of beads coupled with Fmoc-isoleucine was separately deprotected for 4 min by the method (4), followed by coupling with Fmoc-Gly. Concurrently, the other aliquots of beads were mixed and deprotected for 4 min by the same method. All beads were then combined together and Fmoc-deprotected. By repeating this cycle, the beads were successively assembled up to four residues. In the last cycle, the beads were first split into two portions: 0.1 g and 1.6 g. The small aliquot of beads (0.1 g) was coupled with Fmoc-isoleucine and then thoroughly Alloc-deprotection by the method (3), followed by acylation with acetic acid (3 equiv)/HOBt (3 equiv)/DIC (3 equiv); The other aliquot of beads (1.6 g) was thoroughly Alloc-deprotected and then split into sixteen aliquots, followed by coupling with a Fmoc-amino acid each. All beads were combined together, Fmoc-deprotected and after washing, treated by TFA/TIS/H₂O (30 mL, 95:2.5:2.5, v/v/v) for 2.5 h. The beads were thoroughly washed and stored in 70% ethanol. FIG. 6 shows the general structure of ladder compounds on a prepared encoded pentapeptide library bead, and hypothetical mass spectrum of releasate with six mass peaks. FIG. 7 shows typical mass spectra of releasate obtained from a single pentapeptide library bead prepared by the new ladder-synthesis method.

What is claimed is:

1. A method for preparing a library of compounds, comprising:
a) providing a plurality of beads wherein each of said beads has an interior and an exterior portion and wherein each of said beads is divided into a plurality of zones extending from said exterior into said interior and wherein each of said zones consists of a plurality of reactive functional groups;
b) contacting a first bead with a protective component such that said reactive functional groups of said first bead react with said protective component to afford a protected functional group;
c) contacting said first bead with a deprotecting component such that said protected functional groups in a first zone on said exterior of said first bead revert to said reactive functional groups;
d) contacting said first bead with a first reactive component such that said reactive functional groups in said first zone react with said first reactive component to afford a first building block of a compound precursor;
e) contacting said first bead with a deprotecting component such that said protected functional groups in a subsequent zone on said interior of said first bead revert to said reactive functional groups;
f) contacting said first bead with a subsequent reactive component such that said compound precursor reacts with said subsequent reactive component to afford a subsequent building block of said compound precursor, said reactive functional groups in said subsequent zone react with said subsequent reactive component to afford a coding tag, and any coding tag in any previous zone reacts with said subsequent reactive component to afford a coding tag additionally coding for said subsequent building block;
g) repeating steps e)-f) until said first compound has been prepared; and
h) subjecting additional beads to steps b)-g) with additional reactive components to prepare said library of compounds.

2. The method of claim 1, further comprising the following step:
i) cleaving all or a portion of said compounds from all or a portion of said beads.

3. The method of claim 2, wherein all of said compounds are cleaved from each of said beads.

4. The method of claim 2, wherein a portion of said compounds is cleaved from each said beads.

5. The method of claim 1, wherein said reactive component reacts with said reactive functional groups via a reaction selected from the group consisting of amine acylation, reductive alkylation, aromatic reduction, aromatic acylation, aromatic cyclization, aryl-aryl coupling, [3+2] cycloaddition, Mitsunobu reaction, nucleophilic aromatic substitution, sulfonylation, aromatic halide displacement, Michael addition, Wittig reaction, Knoevenagel condensation, reductive amination, Heck reaction, Stille reaction, Suzuki reaction, Aldol condensation, Claisen condensation, amino acid coupling, amide bond formation, acetal formation, Diels-Alder reaction, [2+2] cycloaddition, enamine formation, esterification, Friedel Crafts reaction, glycosylation, Grignard reaction, Homer-Emmons reaction, hydrolysis, imine formation, metathesis reaction, nucleophilic substitution, oxidation, Pictet-Spengler reaction, Sonogashira reaction, thiazolidine formation, thiourea formation and urea formation.

6. A method for preparing a library of compounds, comprising:
a) providing a plurality of beads wherein each of said beads has an interior and an exterior portion and wherein each of said beads is divided into a plurality of zones extending from said exterior into said interior and wherein each of said zones consists of a plurality of reactive functional groups and a plurality of linkers, and wherein each of said reactive functional groups is independently connected to each of said beads through each of said linkers;
b) contacting a first bead with a protective component such that said reactive functional groups of said first bead react with said protective component to afford a protected functional group;
c) contacting said first bead with a deprotecting component such that said protected functional groups in a first zone on said exterior of said first bead revert to said reactive functional groups;
d) contacting said first bead with a first reactive component such that said reactive functional groups in said first zone react with said first reactive component to afford a first building block of a compound precursor;
e) contacting said first bead with a deprotecting component such that said protected functional groups in a subsequent zone on said interior of said first bead revert to said reactive functional groups;
f) contacting said first bead with a subsequent reactive component such that said compound precursor reacts with said subsequent reactive component to afford a subsequent building block of said compound precursor, said reactive functional groups in said subsequent zone react with said subsequent reactive component to afford a coding tag, and any coding tag in any previous zone reacts with said subsequent reactive component to afford a coding tag additionally coding for said subsequent building block;
g) repeating steps e)-f) until said first compound has been prepared; and
subjecting additional beads to steps b)-g) with additional reactive components to prepare said library of compounds.

7. A method for preparing a library of compounds in accordance with claim 1, further comprising:
a) contacting the beads of step h) with a first modifying agent to afford a modified compound and modified coding tags; and
b) repeating step a) with additional modifying agents to prepare said library of compounds.

8. A library of compounds prepared by the method of claim 1.

9. A library of compounds prepared by the method of claim 2.

10. The method of claim 1, wherein said library of compounds is prepared using a split-pool methodology.

11. A method for preparing a coded library of compounds, comprising:
a) providing a plurality of beads, wherein each said beads has an interior portion and an exterior portion and wherein each of said beads is divided into a plurality of zones extending from said exterior portion into said interior portion and wherein each of said zones consists of a plurality of reactive functional groups;
b) contacting each of said beads with a protective component;
c) contacting each of said beads with a deprotecting component;
d) splitting the beads into two or more separate pools;
e) contacting the first reactive components with one or more first reactive functional groups in the two or more separate pools such that a first reactive functional group reacts with one of the first reactive components to afford a first building block, and a first reactive functional group reacts with one of the first reactive components to afford a first coding building block, wherein the contacting step yields subsequent compound precursors;
f) mixing the subsequent compound precursors from the two or more separate pools into a single pool;
g) splitting the subsequent compound precursors into two or more separate pools;
h) contacting the subsequent compound precursors in the two or more separate pools with a successive reactive component such that a subsequent reactive functional group reacts with the successive reactive component to afford a subsequent building block, and a subsequent reactive functional group reacts with the successive reactive component to afford a subsequent coding building block, wherein the contacting step yields further compound precursors;
i) repeating steps f)-h), wherein the further compound precursors of step h) become the subsequent compound precursors of step f), until the library of compounds has been prepared.

12. A method for identifying a compound that binds to a target, said method comprising:
a) contacting a compound prepared by the method of claim 1 with said target; and
b) determining the functional effect of said compound upon said target.

13. The method of claim 12, wherein the compound is attached to a bead.

14. The method of claim 12, wherein the compound is detached from a bead.

15. A method for identifying a compound that binds to a target, said method comprising:
a) contacting a compound prepared by the method of claim 2 with said target; and
b) determining the functional effect of said compound upon said target.

16. A method for identifying a compound in a library of compounds, comprising:
a) cleaving each of a series of compounds and each of a series of coding tags from each of beads;
b) subjecting said compounds and said coding tags to mass spectral analysis; and
c) calculating the mass difference between the mass of a compound peak or a coding peak and a peak corresponding to a linker in order to identify said compound.

17. A method for preparing a library of compounds, comprising:
a) providing a plurality of beads wherein each of said beads has an exterior portion and an interior portion and wherein each of said beads is divided into a plurality of zones extending from said exterior into said interior; and
b) attaching each of said compounds in a first zone on said exterior portion of each of said beads and a coding tag in each of a subsequent zone on the interior portion of each of said beads to afford a coded library of compounds.
